(19) United States
(12) Patent Application Publication
(10) Pub. No.: US 2010/0149153 A1
(43) Pub. Date: Jun. 17, 2010

(54) Display device, display device drive method, and electronic apparatus

(75) Inventors: Tetsuro Yamamoto, Kanagawa (JP); Katsuhide Uchino, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 12/591,707

(22) Filed: Nov. 30, 2009

(30) Foreign Application Priority Data
Dec. 17, 2008 (JP) 2008-320597

(51) Int. Cl. G09G 5/00; G06F 3/038

(52) U.S. Cl. 345/211; 345/214

(57) ABSTRACT

In a display device in which pixels are arranged in a matrix, each pixel has an electro-optical element, a write transistor that writes a video signal, a drive transistor that drives the electro-optical element in accordance with the video signal written by the write transistor, a storage capacitor that is connected between a gate electrode and a source electrode of the drive transistor to store the video signal written by the write transistor. Current is prevented from flowing to the drive transistor when the write transistor writes the video signal.

### BACKGROUND OF THE INVENTION

1. Field of the Invention

The present invention relates to display devices, display-device drive methods, and electronic apparatuses. In particular, the present invention relates to a flat (flat-panel) display device in which pixels including electro-optical elements are two-dimensionally arranged in a matrix, a drive method for the display device, and an electronic apparatus having the display device.

2. Description of the Related Art

In recent years, in the field of display devices for displaying images, flat display devices in which pixels (which may be referred to as “pixel circuits” hereinafter) including light-emitting elements are two-dimensionally arranged in a matrix are becoming widespread rapidly. One example of available flat display devices is a display device that uses, as light emitting elements for pixels, current-driven electro-optical elements having light-emission luminances that change in accordance with the values of currents flowing through the elements. As the current-driven electro-optical elements, organic EL (electroluminescent) elements that utilize the phenomenon of emitting light when an electric field is applied to an organic thin film are available.

An organic EL display device using the organic EL elements as light emitting elements for the pixels has the following features. The organic EL elements can be driven with a voltage of 10 V or less and thus are low in power consumption. Since the organic EL elements are self-light-emitting elements, visibility of an image is high compared to a liquid-crystal display device that displays an image through liquid crystal by controlling, for each pixel, the intensity of light emitted from a light source. Furthermore, the organic EL elements do not use a light source, such as a backlight, thus making it easy to achieve reductions in weight and thickness. In addition, the response speed of the organic EL elements is on the order of several microseconds, which is quite high, and thus, no afterimage is produced during display of a moving image.

The organic EL display device can employ a simple (passive) matrix system and an active matrix system as its drive system, as in the liquid-crystal display devices. However, although the simple matrix display device has a simple structure, the period of light emission of the electro-optical elements is reduced as the number of scan lines (or, the number of pixels) increases. Thus, there is a problem in that it is difficult to achieve a large-sized, high-definition display device.

Accordingly, in recent years, an active matrix display device in which currents flowing through electro-optical elements are controlled by active elements (e.g., insulated-gate field effect transistors) provided in the same pixels as for the electro-optical elements is being actively developed. As insulated-gate field effect transistors, TFTs (thin film transistors) are used in general. For the active matrix display device, since the electro-optical elements continuously emit light through one-frame period, it is easy to achieve a large-size, high-definition display device.

In general, the I-V (current-voltage) characteristic of an organic EL element deteriorates with time (this deterioration may be called “age-related deterioration”). In a pixel circuit in which an n-channel TFT is particularly used as a transistor (referred to as a “drive transistor” hereinafter) that drives an organic EL element by supplying current thereto, when the I-V characteristic of the organic EL element deteriorates with time, a gate-source voltage Vgs of the drive transistor changes. As a result, the light-emission luminance of the organic EL element changes. This is caused by the configuration in which the organic EL element is connected to the source electrode of the drive transistor.

This issue will now be described in more detail. The source voltage of the drive transistor is determined by the operating points of the drive transistor and the organic EL element. When the I-V characteristic of the organic EL element deteriorates, the operating points of the drive transistor and the organic. EL element vary. Thus, even when the same voltage is applied to the gate electrode of the drive transistor, the source voltage of the drive transistor changes. Consequently, the source-gate voltage Vgs of the drive transistor changes, so that the value of current flowing through the drive transistor changes. As a result, the value of current flowing through the organic EL element also changes, so that the light-emission luminance of the organic EL element also changes.

In particular, in a pixel circuit using a polysilicon TFT, the transistor characteristic of the drive transistor may change with time or may vary from one pixel from another due to variations in the manufacturing process, in addition to the age-related deterioration of the I-V characteristic of the organic EL element. That is, the transistor characteristics of the drive transistors in the individual pixels have variations. Examples of the transistor characteristics include a threshold voltage Vth of the drive transistor and a mobility μ of a semiconductor thin film that provides a channel of the drive transistor (the mobility is simply referred to as “mobility μ of the drive transistor” hereinafter).

When the transistor characteristics of the drive transistors of the pixels are different from each other, the values of currents flowing through the drive transistors in the pixels vary from one another. Thus, even when the same voltage is applied to the gate electrodes of the pixels, variations occur in the light-emission luminances of the organic EL elements of the pixels. Consequently, uniformity on the screen is impaired.

Accordingly, technologies for providing each pixel circuit with multiple correction (compensation) functions have been proposed (e.g., Japanese Unexamined Patent Application Publication No. 2007-310311) in order to maintain the light-emission luminance of the organic EL element constant without an influence of age-related deterioration of the I-V characteristic of the organic EL element and age-related changes or the like in the transistor characteristic of the drive transistor.

The multiple correction functions include a function for compensating for variations in the I-V characteristic of the organic EL element, a function for correcting variations in the threshold voltage Vth of the drive transistor, and a function of correcting variations in the mobility μ of the drive transistor. Hereinafter, correction of variations in the threshold voltage Vth of the drive transistor is referred to as “threshold correction” and correction of variations in the mobility μ of the drive transistor is referred to as “mobility correction”.

Provision of each pixel circuit with correction functions makes it possible to maintain the light-emission luminance of the organic EL element constant without an influence of age-related deterioration of the I-V characteristic of the organic EL element and age-related changes in the transistor characteristic of the drive transistor. Consequently, it is possible to improve the display quality of the organic EL display device.

### SUMMARY OF THE INVENTION

The display device disclosed in Japanese Unexamined Patent Application Publication No. 2007-310311 performs mobility correction processing while increasing a source voltage Vs of the drive transistor (details of the operation is described below). Thus, in order to obtain a desired light-emission luminance, a video-signal signal voltage applied to the gate electrode of the drive transistor is increased by an amount corresponding to an increase in the source voltage Vs. This is because the light-emission luminance of the organic EL element is determined by a drive current corresponding to a voltage between the gate and the source of the drive transistor.

The video-signal signal voltage is written from a driver, which is a signal source outside the panel, to a signal line and is written to a pixel in a selected row through the signal line. The signal line has a parasitic capacitance. When the video-signal signal voltage is written to the signal line, power consumed by the driver is proportional to the square of the signal voltage. Thus, when the video-signal signal voltage increases, the power consumed by the driver and also the power consumed by the entire display device increase by an amount corresponding to the increase in the signal voltage.

The display device disclosed in Japanese Unexamined Patent Application Publication No. 2007-310311 executes the mobility correction processing in parallel with processing for writing the video-signal signal voltage, based on the premise that the mobilities μ of the drive transistors vary from one pixel to another. With improvements in the process technology in recent years, there is a trend toward reduction in variations (i.e., smaller variations) in the mobilities μ of the drive transistors. When a configuration for performing mobility correction processing is employed despite small variations in the mobilities μ of the drive transistors, the video-signal signal voltage is generally increased and thus the driver for writing the signal voltage wastes power.

Accordingly, it is desirable to provide a display device that is capable of achieving a reduction in power consumption by reducing the video-signal signal voltage, a drive method for the display device, and an electronic apparatus having the display device.

Accordingly, according to an embodiment of the present invention, there is provided a technology for a display device in which pixels are arranged in a matrix. Each pixel having an electro-optical element, a write transistor that writes a video signal, a drive transistor that drives the electro-optical element in accordance with the video signal written by the write transistor, a storage capacitor that is connected between a gate electrode and a source electrode of the drive transistor to store the video signal written by the write transistor. In the display device, current is prevented from flowing to the drive transistor when the write transistor writes the video signal.

Thus, during writing of the video signal, current is prevented from flowing to the drive transistor. With this arrangement, even when the video signal is written, the source voltage of the drive transistor does not increase since no current flows to the drive transistor. Thus, when negative feedback having an amount of feedback corresponding to the current flowing to the drive transistor is applied to the gate-source voltage of the drive transistor, mobility correction processing that cancels dependence of the drain-source current of the drive transistor on the mobility is not performed. Since the source of the drive transistor does not increase during writing of the video signal, the video-signal signal voltage can be reduced compared to a case in which the mobility correction processing is performed.

According to the present invention, the video-signal signal voltage can be reduced compared to a case in which the mobility correction processing is performed. Thus, it is possible to reduce the power consumed by a driver for writing the signal voltage and also to reduce the power consumed by the entire display device.

### BRIEF DESCRIPTION OF THE DRAWINGS

FIG. 1 is a system block diagram showing an overview of the configuration of an organic EL display device according to a reference example;

FIG. 2 is a circuit diagram showing an example of the configuration of a pixel (pixel circuit) for use in the organic EL display device according to the reference example;

FIG. 3 is a cross-sectional view showing one example of the structure of a pixel;

FIG. 4 is a timing waveform diagram illustrating the circuit operation of the organic EL display device according to the reference example;

FIGS. 5A to 5D are operation diagrams illustrating the circuit operation of the organic EL display device according to the reference example;

FIGS. 6A to 6D are operation diagrams illustrating the circuit operation of the organic EL display device according to the reference example;

FIG. 7 is a graph illustrating a problem resulting from variations in threshold voltages Vth of drive transistors;

FIG. 8 is a graph illustrating a problem resulting from variations in mobilities μ of the drive transistors;

FIGS. 9A to 9C are graphs illustrating the relationship between a signal voltage Vsig of a video signal and a drain-source current Ids of a drive transistor in the presence/absence of threshold correction and mobility correction;

FIG. 10 is a system block diagram showing an overview of the configuration of an organic EL display device according to one embodiment of the present invention;

FIG. 11 is a circuit diagram showing an example of the configuration of a pixel for use in the organic EL display device according to the present embodiment;

FIG. 12 is a timing waveform diagram illustrating the circuit operation of the organic EL display device according to the present embodiment;

FIGS. 13A to 13D are operation diagrams illustrating the circuit operation of the organic EL display device according to the present embodiment;

FIGS. 14A to 14D are operation diagrams illustrating the circuit operation of the organic EL display device according to the present embodiment;

FIG. 15 is a graph showing a change in a source voltage Vs of the drive transistor during threshold correction processing;

FIG. 16 is a circuit diagram showing an example of the configuration of a pixel according to a first modification;

FIG. 17 is a circuit diagram showing an example of the configuration of a pixel according to a second modification;

FIG. 18 is a perspective view of a television set to which the present invention is applied;

FIGS. 19A and 19B are a front perspective view and a rear perspective view, respectively, showing the external appearance of a digital camera to which the present invention is applied;

FIG. 20 is a perspective view showing the external appearance of a notebook computer to which the present invention is applied;

FIG. 21 is a perspective view showing the external appearance of a video camera to which the present invention is applied; and

FIGS. 22A to 22G are external views of a mobile phone to which the present embodiment is applied, FIG. 22A being a front view of the mobile phone when it is opened, FIG. 22B being a side view thereof, FIG. 22C being a front view when the mobile phone is closed, FIG. 22D being a left side view, FIG. 22E being a right side view, FIG. 22F being a top view, and FIG. 22G being a bottom view.

### DESCRIPTION OF THE PREFERRED EMBODIMENT

Best mode (hereinafter referred to as an “embodiment”) for carrying out the present invention will be described below with reference to the accompanying drawings. A description below is given in the following sequence:

1. Reference Example (with Mobility Correction Processing)

2. Embodiment (without Mobility Correction Processing)

3. Modifications
3-1. First Modification of Pixel Configuration
3-2. Second Modification of Pixel Configuration

4. Application Examples (Electronic Apparatus)

### 1. Reference Example

### System Configuration

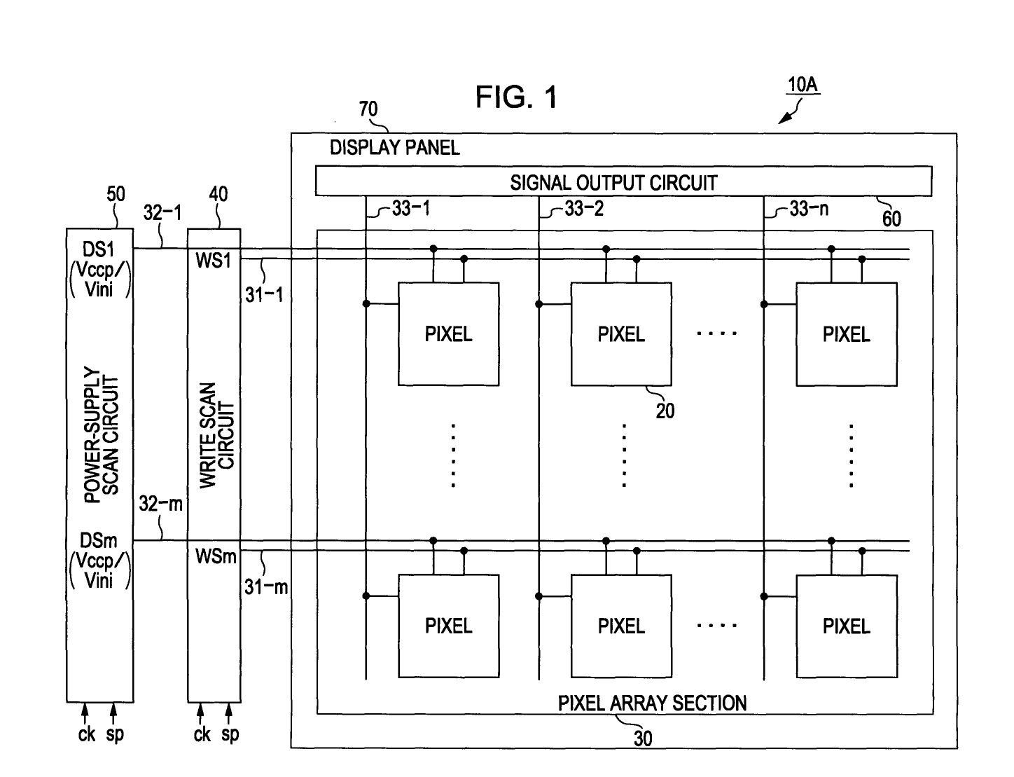

FIG. 1 is a system block diagram showing an overview of the configuration of an active matrix display device according to a reference example. The display device of the reference example corresponds to a display device disclosed in Japanese Unexamined Patent Application Publication No. 2007-310311. A description below is given of an example in which an active matrix organic EL (electroluminescent) display device in which current-driven electro-optical elements (e.g., organic EL elements) having light-emission luminances that change in accordance with the values of currents flowing through the elements are used as light-emitting elements in pixels (pixel circuits).

As shown in FIG. 1, an organic EL display device 10A according to a reference example includes pixels 20 including light-emitting elements, a pixel array section 30 in which the pixels 20 are two-dimensionally arranged in a matrix, and a drive section disposed in the vicinity of the pixel array section 30. The drive section drives light emission of each of the pixels 20 in the pixel array section 30.

The drive section for the pixels 20 includes, for example, a scan drive section and a signal supply section. The scan drive section may have a write scan circuit 40 and a power-supply scan circuit 50 and the signal supply section may have a signal output circuit 60. In the case of the organic EL display device 10A according to the reference example, the signal output circuit 60 is disposed on a display panel (plate) 70 at which the pixel array section 30 is provided, whereas the write scan circuit 40 and the power-supply scan circuit 50, which are included in the scan drive section, are disposed outside the display panel 70.

When the organic EL display device 10A is a black-and-white display device, a single pixel that serves as a unit for forming a black-and-white image corresponds to the pixel 20. When the organic EL display device 10A is a color display device, a single pixel that serves as a unit for forming a color image is constituted by multiple sub pixels and the sub pixels correspond to the pixel 20. More specifically, in the color display device, one pixel is constituted by three sub pixels, for example, a sub pixel for emitting red (R) light, a sub pixel for emitting green (G) light, and a sub pixel for emitting blue (B) light.

However, one pixel is not limited to a combination of sub pixels having the three primary colors including RGB. That is, a sub pixel for another color or sub pixels for other colors may be further added to the three-primary-color sub pixels to constitute a single pixel. More specifically, for example, in order to improve the luminance, a sub pixel for emitting white (W) light may be added to constitute a single pixel or, in order to increase the color reproduction range, at least one sub pixel for emitting complementary color may be added to constitute a single pixel.

In the pixel array section 30, scan lines 31-1 to 31-m and power-supply lines 32-1 to 32-m are arranged in corresponding pixel rows along a row direction (i.e., in a direction in which the pixels 20 in the pixel rows are arranged) so as to correspond to the pixels 20 arranged in m rows×n columns. In addition, signal lines 33-1 to 33-n are arranged in corresponding pixel columns along a column direction (i.e., in a direction in which the pixels 20 in the pixel columns are arranged).

The scan lines 31-1 to 31-m are connected to corresponding row output ends of the write scan circuit 40. The power-supply lines 32-1 to 32-m are connected to corresponding column output ends of the power-supply scan circuit 50. The signal lines 33-1 to 33-n are connected to corresponding column output ends of the signal output circuit 60.

In general, the pixel array section 30 is provided on a transparent insulating plate, such as a glass plate. Thus, the organic EL display device 10A has a flat panel structure. Drive circuits for the pixels 20 in the pixel array section 30 can be fabricated using amorphous silicon TFTs (thin-film transistors) or low-temperature polysilicon TFTs. When low-temperature polysilicon TFTs are used, the write scan circuit 40 and the power-supply scan circuit 50 can also be disposed on the display panel 70.

The write scan circuit 40 includes shift registers or the like that sequentially shift (transfer) a start pulse sp in synchronization with a clock pulse ck. During writing of a video signal to the pixels 20 in the pixel array section 30, the write scan circuit 40 sequentially supplies, for each row, write scan signals WS (WS1 to WSm) to the scan lines 31-1 to 31-m to thereby sequentially scan the pixels 20.

The power-supply scan circuit 50 includes shift registers or the like that sequentially shift a start pulse sp in synchronization with a clock pulse ck. In synchronization with line-sequential scanning performed by the write scan circuit 40, the power-supply scan circuit 50 supplies power-supply potentials DS (DS1 to DSm) to the power-supply lines 32-1 to 32-m. Each power-supply potential DS is switched between a first potential power-supply potential Vccp and a second power-supply potential Vini, which is lower than the first power-supply potential Vccp. Through the switching between the power supply potentials Vccp and Vini of the power-supply potential DS, light emission/non-emission of the pixels 20 is controlled.

The signal output circuit 60 appropriately selects one of a video-signal signal voltage (which may be simply referred to as a “signal voltage”) Vsig and a reference potential Vofs. The signal voltage Vsig is based on luminance information supplied from a signal supply source (not shown). The reference potential Vofs, selectively output from the signal output circuit 60, serves as a reference potential for the signal voltage Vsig of the video signal (and corresponds to, foe example, a potential for a black level of a video signal.

The signal output circuit 60 may have a circuit configuration based on a time-division drive system. The time-division drive system is also called a “selector system” in which multiple signal lines are assigned, as one unit (or as a set), to one output end of a driver (not shown) that serves as a signal supply source. In the time-division drive system, the signal lines are sequentially selected in a time-divided manner, and video signals time-sequentially output for each output end of the driver are sorted and supplied in a time-divided manner to thereby drive the signal lines.

As one example, in the case of a color display device, for each set of three adjacent R, G, and B pixel columns, the driver time-sequentially supplies R, G, and B video signals to the signal output circuit 60 in one horizontal period. The signal output circuit 60 includes selectors (selection switches) provided so as to correspond to the corresponding three (R, G, and B) pixel columns. The selectors sequentially perform an ON operation in a time-divided manner to write corresponding R, G, and B video signals to the signal lines in a time-divided manner.

Although three (R, G, and B) pixel columns (signal lines) are described, the present invention is not limited to this example. The use of the time-division drive system (the selector system) has an advantage. That is, the number of outputs of the driver, the number of wiring lines between the driver and the signal output circuit 60, and also the number wiring lines between the driver and the display panel 70 can be reduced to 1/x of the number of signal lines, where x indicates the number of time divisions and is an integer or 2 or more.

The signal voltage Vsig and the reference potential Vofs selectively output from the signal output circuit 60 are written, for each row, to the corresponding pixels 20 in the pixel array section 30 through the signal lines 33-1 to 33-n. That is, the signal output circuit 60 has a line-sequential writing drive system for writing the signal voltage Vsig for each row (line).

### (Pixel Circuit)

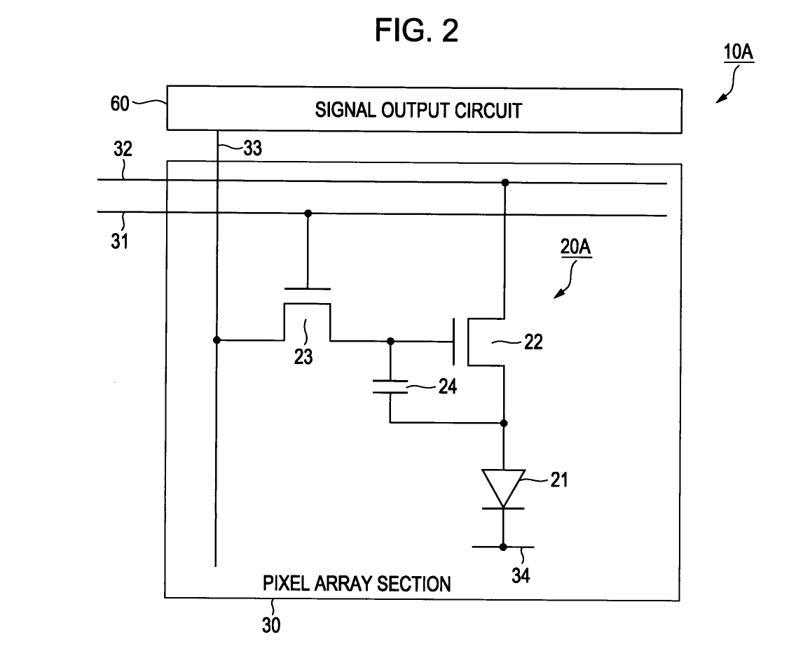

FIG. 2 is a circuit diagram showing an example of the configuration of a pixel (pixel circuit) 20A for use in the organic EL display device 10A according to the reference example.

As shown in FIG. 2, the pixel 20A includes, for example, an organic EL element 21, which is a current-driven electro-optical element, and a drive circuit for driving the organic EL element 21. The organic EL element 21 has a light-emission luminance that changes in accordance with the value of current flowing through the element. The organic EL element 21 has a cathode electrode connected a common power-supply line 34 that is connected to all pixels 20A (this wiring may be referred to as “common wiring”).

The drive circuit for driving the organic EL element 21 has a drive transistor 22, a write transistor (sampling transistor) 23, and a storage capacitor 24. In this case, the drive transistor 22 and the write transistor 23 are implemented by n-channel TFTs. However, this combination of the conductivity types of the drive transistor 22 and the write transistor 23 is merely one example, and thus the combination is not limed thereto.

When n-channel TFTs are used for the drive transistor 22 and the write transistor 23, an amorphous silicon (a-Si) process can be used. The use of the a-Si process makes it possible to reduce the cost of the plate for fabricating the TFTs and thus makes it possible to reduce the cost of the organic EL display device 10A. When a combination of the drive transistor 22 and the write transistor 23 having the same conductivity type is used, both transistors 22 and 23 can be fabricated in the same process, thereby making it possible to contribute to a reduction in the cost.

A first electrode (source/drain electrode) of the drive transistor 22 is connected to an anode electrode of the organic EL element 21 and a second electrode (drain/source electrode) of the drive transistor 22 is connected to a corresponding one of the power-supply lines 32 (32-1 to 32-m).

A gate electrode of the write transistor 23 is connected to a corresponding one of the scan lines 31 (31-1 to 31-m), a first electrode (source/drain electrode) of the write transistor 23 is connected to a corresponding one of the signal lines 33 (33-1 to 33-n), and a second electrode (drain/source electrode) of the write transistor 23 is connected to a gate electrode of the drive transistor 22.

The expression “first electrodes” of the drive transistor 22 and the write transistor 23 refer to metal wiring lines electrically connected to source/drain regions and the expression “second electrodes” refer to metal wiring lines electrically connected to drain/source regions. Depending upon a potential relationship between the first electrode and the second electrode, the first electrode acts as a source electrode or drain electrode or the second electrode acts as a drain electrode or source electrode.

A first electrode of the storage capacitor 24 is connected to the gate electrode of the drive transistor 22 and a second electrode of the storage capacitor 24 is connected to the first electrode of the drive transistor 22 and the anode electrode of the organic EL element 21.

The drive circuit for the organic EL element 21 is not limited to the circuit configuration including two transistors, i.e., the drive transistor 22 and the write transistor 23, and a single capacitance element, i.e., the storage capacitor 24. For example, the drive circuit may have a circuit configuration in which a first electrode is connected to the anode electrode of the organic EL element 21 and a second electrode is connected to a fixed potential to compensate for a shortage of the capacity of the organic EL element 21.

The write transistor 23 in the pixel 20A having the above-described configuration enters a conductive state in response to a high (i.e., active) write scan signal WS supplied from the write scan circuit 40 to the gate electrode through the scan line 31. Thus, the write transistor 23 samples the reference potential Vofs or the video-signal signal voltage Vsig corresponding to the luminance information supplied from the signal output circuit 60 through the signal line 33 and writes the sampled potential Vofs or signal voltage Vsig to the pixel 20A. The written potential Vofs or signal voltage Vsig is applied to the gate electrode of the drive transistor 22 and is also stored by the storage capacitor 24.

When the potential (hereinafter may be referred to as a “power-supply potential”) DS of the corresponding one of the power-supply lines 32 (32-1 to 32-m) is a first power-supply potential Vccp, the drive transistor 22 operates in a saturation region with the first electrode acting as a drain electrode and the second electrode acting as a source electrode. Thus, in response to current supplied from the power-supply line 32, the drive transistor 22 drives the light emission of the organic EL element 21 by supplying drive current thereto.

More specifically, by operating in a saturation region, the drive transistor 22 supplies, to the organic EL element 21, drive current having a current value corresponding to the voltage value of the signal voltage Vsig stored by the storage capacitor 24. Consequently, the organic EL element 21 emits light having a light-emission luminance corresponding to the current value (the amount of current) of the drive current supplied from the drive transistor 22.

When the power-supply potential DS is switched from the first power-supply potential Vccp to the second power-supply potential Vini, the drive transistor 22 operates as a switching transistor with the first electrode acting as a source electrode and the second electrode acting as a drain electrode. Through the switching operation, the drive transistor 22 stops the supply of the drive current to the organic EL element 21 to put the organic EL element 21 into a light non-emission state. That is, the drive transistor 22 also has the function of a transistor for controlling the light emission/non-emission of the organic EL element 21.

Thus, the drive transistor 22 performs a switching operation to provide a period (a light non-emission period) in which the organic EL element 21 does not emit light, and controls the ratio of the light emission period to the light non-emission period of the organic EL element 21 (the control is so called “duty control”). Through the duty control, afterimage involved in the light emission of the pixel 20A through one frame period can be reduced. Thus, in particular, the image quality of a moving image can be enhanced.

Of the first and second power-supply potentials Vccp and Vini selectively supplied from the power-supply scan circuit 50 through the power-supply line 32, the first power-supply potential Vccp is a power-supply potential for supplying, to the drive transistor 22, drive current for driving light emission of the organic EL element 21. The second power-supply potential Vini is a power-supply potential for reverse-biasing the organic EL element 21. The second power-supply potential Vini is set lower than the reference potential Vofs, which serves as a reference for the signal voltage. For example, the second power-supply potential Vini is set to a potential that is lower than Vofs-Vth, preferably, to a potential that is sufficiently lower than Vofs-Vth, where Vth indicates the threshold voltage of the drive transistor 22.

### (Pixel Structure)

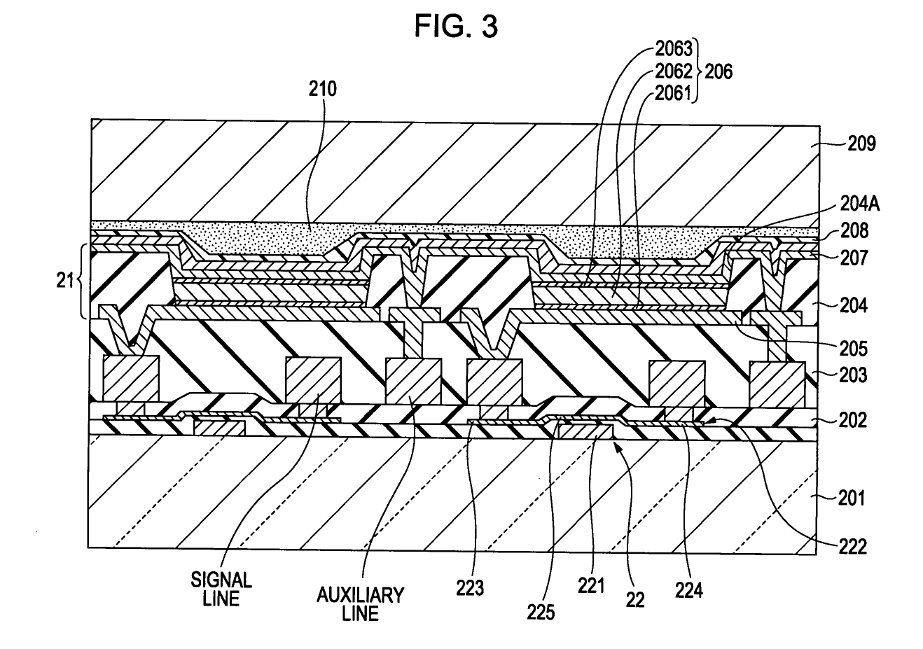

FIG. 3 is a cross-sectional view showing one example of the structure of the pixel 20A. As shown in FIG. 3, the pixel 20A is provided above a glass plate 201 having the drive circuit including the drive transistor 22 and so on. More specifically, the pixel 20A has a structure in which an insulating layer 202, an insulating planarized layer 203, and a wind insulating layer 204 are provided above the glass plate 201 in that order and the organic EL element 21 is provided in a depression 204A in the wind insulating layer 204. In this case, of the elements included in the drive circuit, only the drive transistor 22 is illustrated and other elements are not shown.

The organic EL element 21 has an anode electrode 205 made of metal or the like, an organic layer 206 provided above the anode electrode 205, and a cathode electrode 207 provided above the organic layer 206 and having a transparent conductive layer or the like that is common to all pixels. The anode electrode 205 is provided at a bottom portion of the depression 204A in the wind insulating layer 204.

The organic layer 206 in the organic EL element 21 is formed by sequentially depositing a hole transport layer/hole injection layer 2061, a light emitting layer 2062, an electron transport layer 2063, and an electron injection layer (not shown) above the anode electrode 205. Through the current driving performed by the drive transistor 22 shown in FIG. 2, current flows from the drive transistor 22 to the organic layer 206 through the anode electrode 205, so that electrons and holes are re-coupled together in the light-emitting layer 2062 in the organic layer 206 to thereby emit light.

The drive transistor 22 has a gate electrode 221, a channel forming region 225, and a source/drain region 223, and a drain/source region 224. The channel forming region 225 is located so as to oppose the gate electrode 221 of the semiconductor layer 222. The source/drain region 223 and the drain/source region 224 are provided at two opposite ends of the channel forming region 225 on the semiconductor layer 222. The source/drain region 223 is electrically connected to the anode electrode 205 of the organic EL element 21 through a contact hole.

As shown in FIG. 3, for each pixel, the organic EL element 21 is provided above the glass plate 201, which is provided with the drive circuit including the drive transistor 22, with the insulating layer 202, the insulating planarized layer 203, and the wind insulating layer 204 interposed between the organic EL element 21 and the glass plate 201. A sealing plate 209 is bonded to a passivation layer 208 by adhesive 210, so that the sealing plate 209 seals the organic EL element 21 to thereby provide the display panel 70.

### Circuit Operation of Organic EL Display Device According to Reference Example

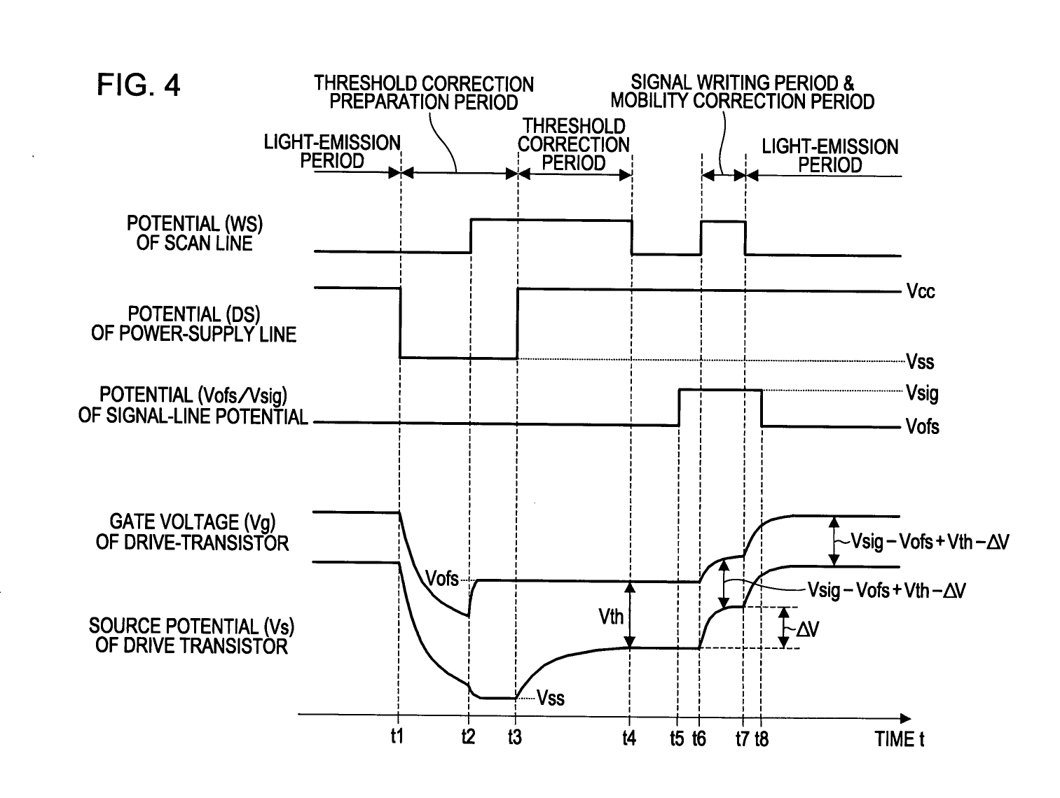

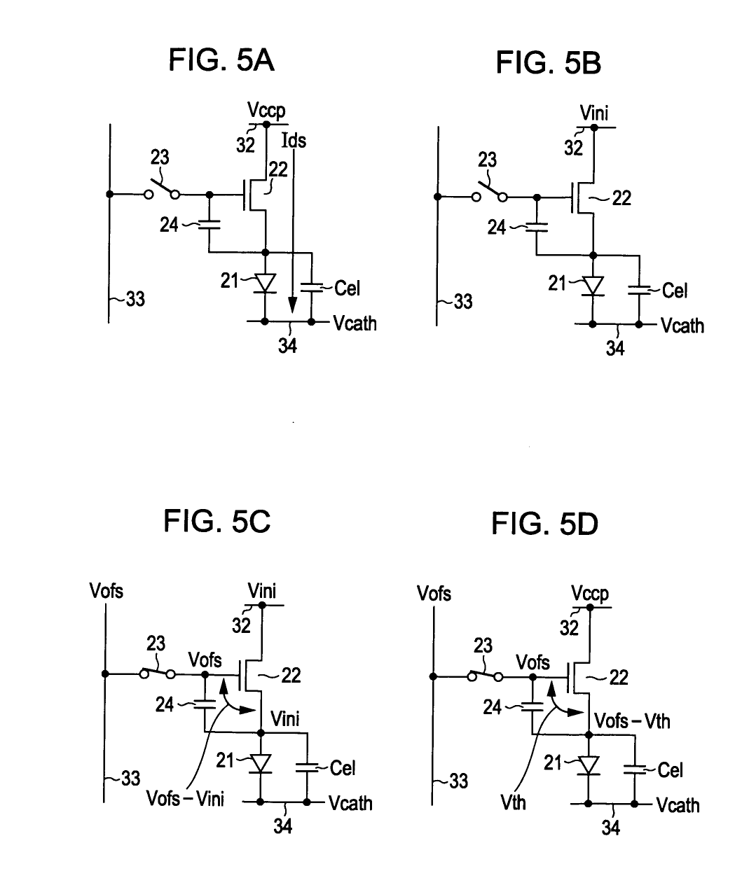

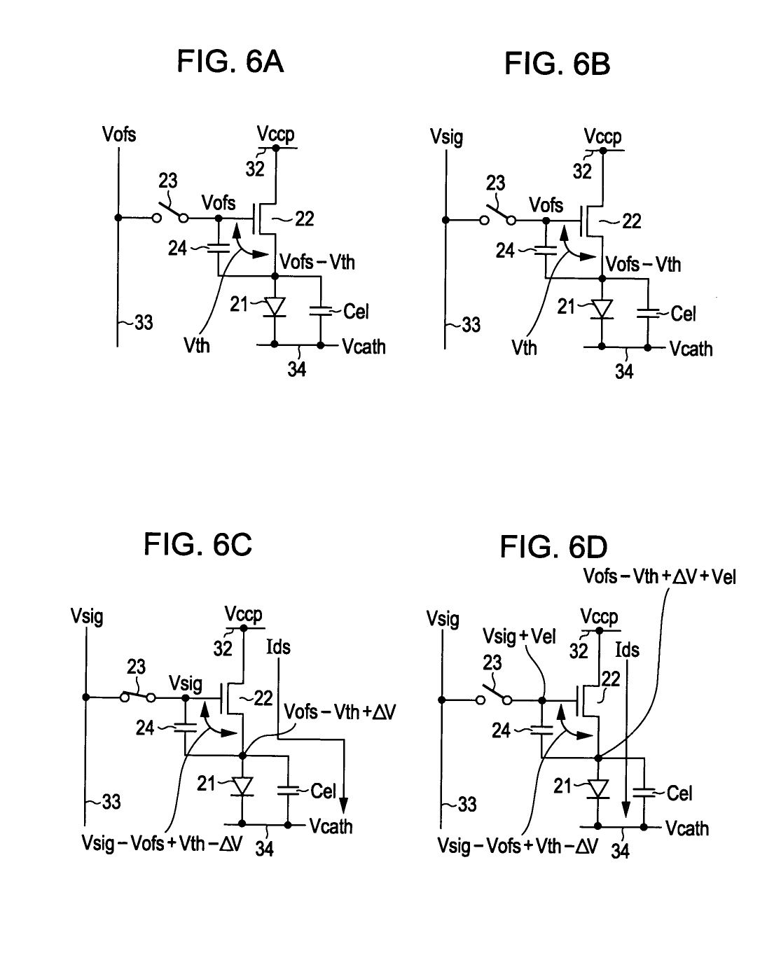

Next, the circuit operation of the organic EL display device 10A according to the reference example in which the pixels 20A having the above-described configuration are two-dimensionally arranged in a matrix will be described with reference to operation diagrams shown in FIGS. 5A to 6D on the basis of a timing waveform diagram shown in FIG. 4.

In the operation diagrams shown in FIGS. 5A to 6D, the write transistor 23 is illustrated as a symbol representing a switch, for simplification of illustration. The organic EL element 21 has an equivalent capacitance (parasitic capacitance) Cel. Thus, the equivalent capacitor Cel is also illustrated.

The timing waveform diagram of FIG. 4 shows a change in the potential (write scan signal) WS of the scan line 31 (31-1 to 31-m), a change in the potential (power-supply potential) DS of the power-supply line 32 (32-1 to 32-m), and changes in a gate voltage Vg and a source voltage Vs of the drive transistor 22.

### [Light Emission Period for Previous Frame]

In the timing waveform diagram of FIG. 4, a period before time t1 is a period in which the organic EL element 21 emits light for a previous frame (field). In the light emission period for the previous frame, the potential DS of the power-supply line 32 is the first power-supply potential (hereinafter referred to as a “high potential”) Vccp and the write transistor 23 is in the non-conductive state.

At this point, the drive transistor 22 is designed so that it operates in its saturation region. Thus, as shown in FIG. 5A, a drive current (a drain-source current) Ids corresponding to a gate-source voltage Vgs of the drive transistor 22 is supplied from the power-supply line 32 to the organic EL element 21 through the drive transistor 22. Consequently, the organic EL element 21 emits light with a luminance corresponding to the current value of the drive current Ids.

### [Threshold Correction Preparation Period]

At time t1, the operation enters a new frame (a present frame) for line-sequential scanning. As shown in FIG. 5B, the potential DS of the power-supply line 32 changes from the high potential Vccp to the second power-supply potential (hereinafter referred to as a “low potential”) Vini, which is sufficiently lower than Vofs-Vth relative to the reference potential Vofs of the signal line 33.

In this case, a threshold voltage of the organic EL element 21 is represented by Vthel and the potential (cathode potential) of the common power-supply line 34 is represented by Vcath. In this case, when the Low potential Vini s assumed to satisfy Vini<Vthel+Vcath, the source voltage Vs of the drive transistor 22 is substantially equal to the low potential Vini. Thus, the organic EL element 21 is put into a reverse-biased state. Consequently, the light emission of the organic EL element 21 is turned off.

Next, at time t2, the potential WS of the scan line 31 shifts from a low-potential side toward a high-potential side, so that the write transistor 23 is put into a conductive state, as shown in FIG. 5C. At this point, since the reference potential Vofs is supplied from the signal output circuit 60 to the signal line 33, the gate voltage Vg of the drive transistor 22 becomes the reference potential Vofs. The source voltage Vs of the drive transistor 22 is equal to the potential Vini that is sufficiently lower than the reference potential Vofs.

At this point, the gate-source voltage Vgs of the drive transistor 22 is given by Vofs-Vini. In this case, unless Vofs-Vini is sufficiently larger than the threshold voltage Vth of the drive transistor 22, it is difficult to perform threshold correction processing described below and thus setting is performed so as to satisfy a potential relationship expressed by Vofs−Vini>Vth.

Processing for initialization by fixing (setting) the gate voltage Vg of the drive transistor 22 to the reference potential Vofs and fixing the source voltage Vs to the low potential Vini is processing for preparation (threshold correction preparation) for a stage before the threshold correction processing described below. Thus, the reference potential Vofs and the low potential Vini serve as initialization potentials for the gate voltage Vg and the source voltage Vs of the drive transistor 22.

### [Threshold Correction Period]

Next, at time t3, as shown in FIG. 5D, the potential DS of the power-supply line 32 changes from the low potential Vini to the high potential Vccp, and the threshold correction processing is started while the gate voltage Vg of the drive transistor 22 is maintained. That is, the source voltage Vs of the drive transistor 22 starts to increase toward a potential obtained by subtracting the threshold voltage Vth of the drive transistor 22 from the gate voltage Vg.

Herein, the processing for changing the source voltage Vs toward the potential, obtained by subtracting the threshold voltage Vth of the drive transistor 22 from the initialization potential Vofs, with reference to the initialization potential Vofs of the gate electrode of the drive transistor 22 is referred to as “threshold correction processing”. When the threshold correction processing progresses, the gate-source voltage Vgs of the drive transistor 22 eventually settles to the threshold voltage Vth of the drive transistor 22. A voltage corresponding to the threshold voltage Vth is stored by the storage capacitor 24.

In the period in which the threshold correction processing is performed (i.e., in a threshold correction period), it is necessary to cause current to flow to the storage capacitor 24 and to prevent current from flowing to the organic EL element 21. Thus, the potential Vcath of the common power-supply line 34 is set so that the organic EL element 21 is put into a cut-off state.

Next, at time t4, the potential WS of the scan line 31 shifts toward a low-potential side, so that the write transistor 23 is put into a non-conductive state, as shown in FIG. 6A. At this point, the gate electrode of the drive transistor 22 is electrically disconnected from the signal line 33, so that the gate electrode of the drive transistor 22 enters a floating state. However, since the gate-source voltage Vgs is equal to the threshold voltage Vth of the drive transistor 22, the drive transistor 22 is in a cut-off state. Thus, almost no drain-source current Ids flows to the drive transistor 22.

### [Signal Writing & Mobility Correction Period]

Next, at time t5, as shown in FIG. 6B, the potential of the signal line 33 is switched from the reference potential Vofs to the signal voltage Vsig of the video signal. Subsequently, at time t6, the potential WS of the scan line 31 shifts toward the high-potential side, so that the write transistor 23 enters a conductive state, as shown in FIG. 6C, to sample the signal voltage Vsig of the video signal and to write the signal voltage Vsig to the pixel 20A.

When the write transistor 23 writes the signal voltage Vsig, the gate voltage Vg of the drive transistor 22 becomes the signal voltage Vsig. During drive of the drive transistor 22 with the signal voltage Vsig of the video signal, the threshold voltage Vth of the drive transistor 22 is cancelled by a voltage corresponding to the threshold voltage Vth stored by the storage capacitor 24. Details of the principle of the threshold cancelling are described below.

At this point, the organic EL element 21 is in the cut-off state (a high impedance state). Thus, the current (the drain-source current Ids) flowing from the power-supply line 32 to the drive transistor 22 in accordance with the signal voltage Vsig of the video signal flows to the equivalent capacitor Cel of the organic EL element 21. Upon flow of the drain-source current Ids, charging of the equivalent capacitor Cel of the organic EL element 21 is started.

As a result of charging of the equivalent capacitor Cel, the source voltage Vs of the drive transistor 22 increases with time. Since variations in the threshold voltages Vth of the drive transistors 22 of the pixels have already been cancelled at this point, the drain-source current Ids of the drive transistor 22 depends on the mobility μ of the drive transistor 22.

It is now assumed that the ratio of the voltage Vgs stored by the storage capacitor 24 to the signal voltage Vsig of the video signal (the ratio may also be referred to as a “gain”) is 1 (an ideal value). In this case, the source voltage Vs of the drive transistor 22 increases to a potential expressed by Vofs−Vth+ΔV, so that the gate-source voltage Vgs of the drive transistor 22 reaches a value expressed by Vsig−Vofs+Vth−ΔV.

That is, an increase ΔV in the source voltage Vs of the drive transistor 22 acts so that it is subtracted from the voltage (Vsig−Vofs+Vth) stored by the storage capacitor 24. In other words, the increase ΔV in the source voltage Vs acts so as to discharge the electrical charge in the storage capacitor 24, so that a negative feedback is applied. Thus, the increase ΔV in the source voltage Vs of the drive transistor 22 corresponds to the amount of negative feedback.

When negative feedback having the amount ΔV of feedback corresponding to the drain-source current Ids flowing to the drive transistor 22 is applied to the gate-source voltage Vgs in the manner described above, it is possible to cancel the dependence of the drain-source current Ids of the drive transistor 22 on the mobility μ. Processing for cancelling the dependence on the mobility μ is mobility correction processing for correcting variations in the mobilities μ of the drive transistors 22 of the individual pixels.

More specifically, the higher the signal amplitude Vin (=Vsig−Vofs) of the video signal written to the gate electrode of the drive transistor 22 is, the larger the drain-source current Ids becomes. Thus, the absolute value of the amount ΔV of negative feedback also increases. Thus, the mobility correction processing is performed in accordance with the light-emission luminance level.

When the signal amplitude Vin of the video signal is constant, the absolute value of the amount ΔV of negative feedback increases as the mobility μ of the drive transistor 22 becomes larger. Thus, variations in the mobilities g of individual pixels can be eliminated. That is, the amount ΔV of negative feedback can also be called the amount of correction of the mobility.

### [Light Emission Period]

Next, at time t7, the potential WS of the scan line 31 shifts toward a low-potential side, so that the write transistor 23 is put into a non-conductive state, as shown in FIG. 6D. Consequently, the gate electrode of the drive transistor 22 is electrically disconnected from the signal line 33, so that the gate electrode of the drive transistor 22 enters a floating state.

In this case, when the gate electrode of the drive transistor 22 is in the floating state, the gate voltage Vg also varies in conjunction with (so as to correspond to) variations in the source voltage Vs of the drive transistor 22, since the storage capacitor 24 is connected between the gate and the source of the drive transistor 22. Such an operation in which the gate voltage Vg of the drive transistor 22 varies in conjunction with variations in the source voltage Vs is herein referred to as a “bootstrap operation” performed by the storage capacitor 24.

When the gate electrode of the drive transistor 22 enters a floating state and simultaneously the drain-source current Ids of the drive transistor 22 starts to flow to the organic EL element 21, the anode potential of the organic EL element 21 increases in response to the drain-source current Ids.

When the anode potential of the organic EL element 21 exceeds Vthel+Vcath, the drive current starts to flow to the organic EL element 21 to thereby cause the organic EL element 21 to start light emission. An increase in the anode potential of the organic EL element 21 is equal to the increase in the source voltage Vs of the drive transistor 22. When the source voltage Vs of the drive transistor 22 increases, the bootstrap operation of the storage capacitor 24 causes the gate voltage Vg of the drive transistor 22 to increase in conjunction with the source voltage Vs.

In this case, when the gain of the bootstrap is assumed to be 1 (an ideal value), the amount of increase in the gate voltage Vg is equal to the amount of increase in the source voltage Vs. Therefore, in the light-emission period, the gate-source voltage Vgs of the drive transistor 22 is maintained constant at Vsig−Vofs+Vth-ΔV. At time t8, the potential of the signal line 33 is switched from the signal voltage Vsig of the video signal to the reference voltage Vofs.

In the above-described series of circuit operations, the processing operations of the threshold correction preparation, the threshold correction, the writing (signal writing) of the signal voltage Vsig, and the mobility correction are executed in one horizontal scan period (1H). The processing operations of the signal writing and the mobility correction are executed in parallel in the period of time t6 to time t7.

### (Principle of Threshold Cancelling)

The principle of the threshold correction (i.e., threshold cancelling) of the drive transistor 22 will now be described. As described above, the threshold correction processing is processing in which the source voltage Vs of the drive transistor 22 is changed toward the potential, obtained by subtracting the threshold voltage Vth of the drive transistor 22 from the initialization potential Vofs, with reference to the initialization potential Vofs of the gate voltage Vg of the drive transistor 22.

Since the drive transistor 22 is designed to operate in the saturation region, it operates as a constant current source. As a result of the operation of the constant current source, constant drain-source current (drive current) Ids flows from the drive transistor 22 to the organic EL element 21, and is given by:

Ids=(1/2)·μ(W/L)Cox(Vgs−Vth)² (1),

where W indicates a channel width of the drive transistor 22, L indicates a channel length, and Cox indicates a gate capacitance per unit area.

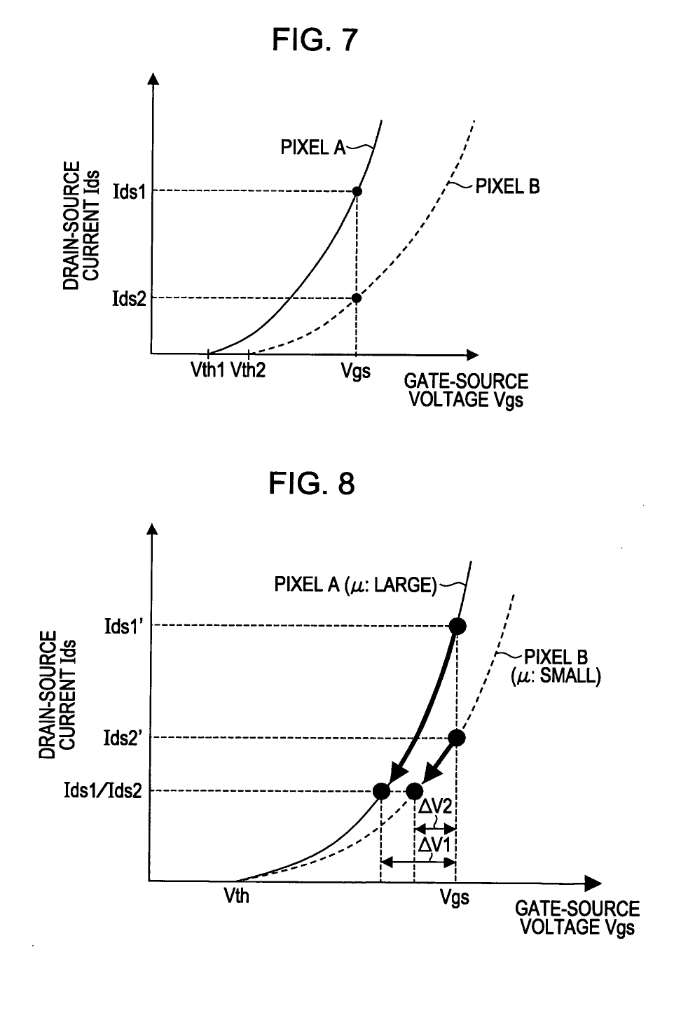

FIG. 7 is a graph showing a characteristic of the drain-source current Ids of the drive transistor 22 versus a characteristic of the gate-source voltage Vgs.

As shown in the graph, if no correction is performed on variations in the threshold voltage Vth of the drive transistor 22 in each individual pixel, the drain-source current Ids corresponding to the gate-source voltage Vgs becomes Ids1 when the threshold voltage Vth is Vth1.

In contrast, when the threshold voltage Vth is Vth2 (Vth2>Vth1), the drain-source current Ids corresponding to the same gate-source voltage Vgs becomes Ids2 (Ids2<Ids). That is, when the threshold voltage Vth of the drive transistor 22 varies, the drain-source current Ids varies even when the gate-source voltage Vgs of the drive transistor 22 is constant.

On the other hand, in the pixel (pixel circuit) 20 having the above-described configuration, the gate-source voltage Vgs of the drive transistor 22 during light emission is expressed by Vsig−Vofs+Vth−ΔV, as described above. Thus, substituting this expression into equation (1) noted above yields the drain-source current Ids given by:

Ids=(1/2)·μ(W/L)Cox(Vsig−Vofs−ΔV)² (2).

That is, the term of the threshold voltage Vth of the drive transistor 22 is cancelled, so that the drain-source current Ids supplied from the drive transistor 22 to the organic EL element 21 does not depend on the threshold voltage Vth of the drive transistor 22. As a result, even when the threshold voltage Vth of the drive transistor 22 is varied for each pixel by the age-related changes or variations in the manufacturing process of the drive transistor 22, the drain-source current Ids does not vary. This makes it possible to maintain the light-emission luminance of the organic EL element 21 constant.

### (Principle of Mobility Correction)

The principle of the mobility correction of the drive transistor 22 will be described next. As described above, in the mobility correction processing, negative feedback having the amount ΔV of correction corresponding to the drain-source current Ids flowing to the drive transistor 22 is applied to the potential difference between the gate and the source of the drive transistor 22. In the mobility correction processing, it is possible to cancel the dependence of the drain-source current Ids of the drive transistor 22 on the mobility μ.

FIG. 8 is a graph showing characteristic curves for comparison between pixel A having a relatively large mobility μ of the drive transistor 22 and pixel B having a relatively small mobility μ of the drive transistor 22. When the drive transistor 22 is implemented by a polysilicon TFT or the like, variations in the mobilities μ of the pixels occur, such as those in pixels A and B.

Consideration is now given to an example in which the signal amplitudes Vin (=Vsig−Vofs) having the same level are written to the gate electrodes of the drive transistors 22 of pixels A and B when mobilities μ in pixels A and B have variations. In this case, when no correction is performed on the mobilities μ, a large difference occurs between drain-source current Ids1′ flowing through pixel A having a large mobility μ and drain-source current Ids2′ flowing through pixel B having a small mobility μ. When the drain-source currents Ids in the pixels have a large difference therebetween due to variations in the mobilities μ of the pixels, uniformity on the screen is impaired.

As is clear from the transistor characteristic given by equation (1) noted above, the drain-source current Ids increases as the mobility μ increases. Thus, the amount ΔV of negative feedback increases as the mobility μ increases. As shown in FIG. 8, the amount ΔV1 of negative feedback in pixel A having a large mobility μ is larger than the amount ΔV2 of negative feedback in pixel B having a small mobility μ.

Accordingly, when the mobility correction processing is performed so that negative feedback having the amount ΔV of feedback corresponding to the drain-source current Ids of the drive transistor 22 is applied to the gate-source voltage Vgs, a larger amount of negative feedback is applied as the mobility μ increases. As a result, it is possible to suppress variations in the mobilities μ of the pixels.

More specifically, when correction corresponding to the amount of negative feedback ΔV1 is performed on pixel A having a large mobility μ, the drain-source current Ids decreases significantly from Ids1′ to Ids1. On the other hand, since the amount of feedback ΔV2 in pixel B having a small mobility μ is small, the drain-source current Ids decreases from Ids2′ to Ids2. This decrease is not so large. As a result, the drain-source current Ids1 in pixel A and the drain-source current Ids2 in pixel B become substantially equal to each other, so that variations in the mobilities μ of the pixels are corrected.

In short, when pixels A and B having different mobilities μ exist, the amount ΔV1 of feedback in pixel A having a large mobility μ becomes larger than the amount ΔV2 of feedback in pixel B having a small mobility μ. That is, for a pixel having a larger mobility μ, the amount of feedback ΔV increases and the amount of decrease in the drain-source current Ids becomes large.

Thus, as a result of applying negative feedback having the amount ΔV of feedback corresponding to the drain-source current Ids of the drive transistor 22 to the gate-source voltage Vgs, current values of the drain-source currents Ids of pixels having different mobilities μ are equalized. As a result, it is possible to correct variations in the mobilities μ of the pixels. That is, the mobility correction processing is processing in which negative feedback having the amount ΔV of feedback corresponding to the current (drain-source current Ids) flowing to the drive transistor 22 is applied to the gate-source voltage Vgs of the drive transistor 22.

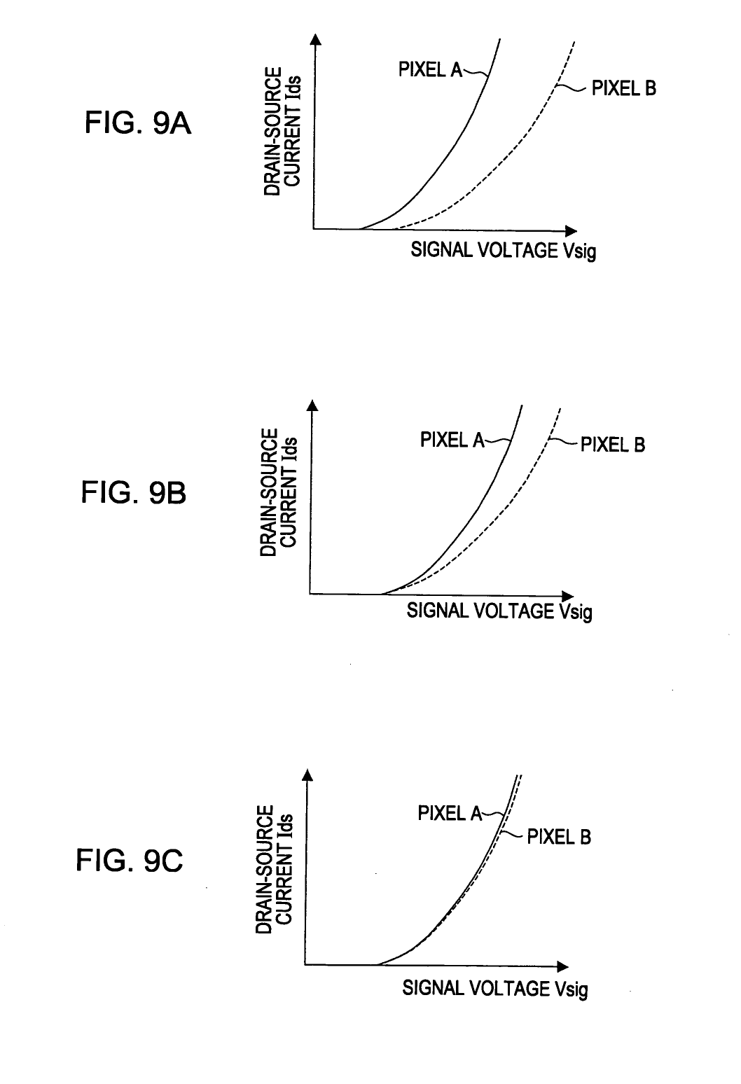

Now, a relationship between the signal potential (sampling potential) Vsig of the video signal and the drain-source current Ids of the drive transistor 22 in the presence/absence of the threshold correction and/or the mobility correction in the pixel (pixel circuit) 20A shown in FIG. 2 will be described with reference to FIGS. 9A to 9D.

FIG. 9A shows a case in which neither the threshold correction processing nor the mobility correction processing is performed, FIG. 9B shows a case in which only the threshold correction processing is performed without performing the mobility correction processing, and FIG. 9C shows a case in which both the threshold correction processing and the mobility correction processing are performed. As shown in FIG. 9A, when neither the threshold correction processing nor the mobility correction processing is performed, a large difference in the drain-source current Ids between pixels A and B occurs due to variations in the threshold voltages Vth and the mobilities μ of pixels A and B.

In contrast, when only the threshold correction processing is performed, variations in the drain-source current Ids can be reduced to some degree but the difference in the drain-source current between pixels A and B, the difference resulting from variations in the mobilities μ of pixels A and B, remains, as shown in FIG. 9B. When both the threshold correction processing and the mobility correction processing are performed, a difference in the drain-source current Ids between pixels A and B, the difference resulting from variations in the threshold voltages Vth and the mobilities μ of pixels A and B, can be substantially eliminated, as shown in FIG. 9C. Thus, no variations in the luminance of the organic EL element 21 occur at any gradation, so that an image with a favorable image quality can be provided.

Since the pixel 20A shown in FIG. 2 has the function of the above-described bootstrap operation performed by the storage capacitor 24 in addition to the functions of the threshold correction and the mobility correction, it is possible to provide the following advantages.

Specifically, even when the source voltage Vs of the drive transistor 22 changes in conjunction with time-related changes in the I-V characteristic of the organic EL element 21, the bootstrap operation of the storage capacitor 24 allows the gate-source potential Vgs of the drive transistor 22 to be maintained constant. Thus, the current flowing to the organic EL element 21 becomes constant without a change. Consequently, the light-emission luminance of the organic EL element 21 is also maintained constant. Thus, even when the I-V characteristic of the organic EL element 21 changes with time, an image that is unaffected by a luminance deterioration caused by the change can be displayed.

### (Failure Involved in Mobility Correction Processing)

As described above, in order to correct variations in the mobility μ based on the premise that the mobility μ of the drive transistor 22 varies for each pixel, the organic EL display device 10A according to the reference example executes the mobility correction processing in parallel with the signal write processing.

As is clear from the above-described circuit operation, the mobility correction processing is performed while the source voltage Vs of the drive transistor 22 is being increased. Thus, as described above, in order to obtain a desired light-emission luminance, the source voltage Vs of the signal voltage Vsig of the video signal applied to the gate electrode of the drive transistor 22 has to be increased by an amount corresponding to the increase in the source voltage Vs.

On the other hand, in recent years, development of a process technology is under way so as to reduce variations in the mobility μ of the drive transistor 22. A reduction in variations in the mobility μ of the drive transistor 22 can eliminate performing the mobility correction processing. The organic EL display device 10A according to the reference example, however, has a pixel configuration for executing the mobility correction processing in parallel with the signal write processing.

As described above, in order to execute the mobility correction processing, the signal voltage Vsig of the video signal has to be increased by an amount corresponding to the increase in the source voltage Vs of the drive transistor 22, as opposed to a case in which the mobility correction processing is not performed. Thus, in a display device having small variations in the mobilities μ of the drive transistors 22, a driver that handles the signal voltages Vsig wastes power, even though when it is not necessary to perform the mobility correction processing. This can becomes a hindrance to a reduction in the power consumption in the entire display device.

### 2. Embodiment

In an embodiment of the present invention, current is prevented from flowing to a drive transistor 22 when the signal voltage Vsig of a video signal is written, and the threshold correction processing is executed and the mobility correction processing is not executed. With this arrangement, the signal voltage Vsig of the video signal can be reduced compared to a case in which the configuration for performing the mobility correction processing is performed. Thus, it is possible to reduce the power consumed by the driver for writing the signal voltage Vsig and also to reduce the power consumed by the entire display device. The present embodiment will be described below in detail.

### [System Configuration]

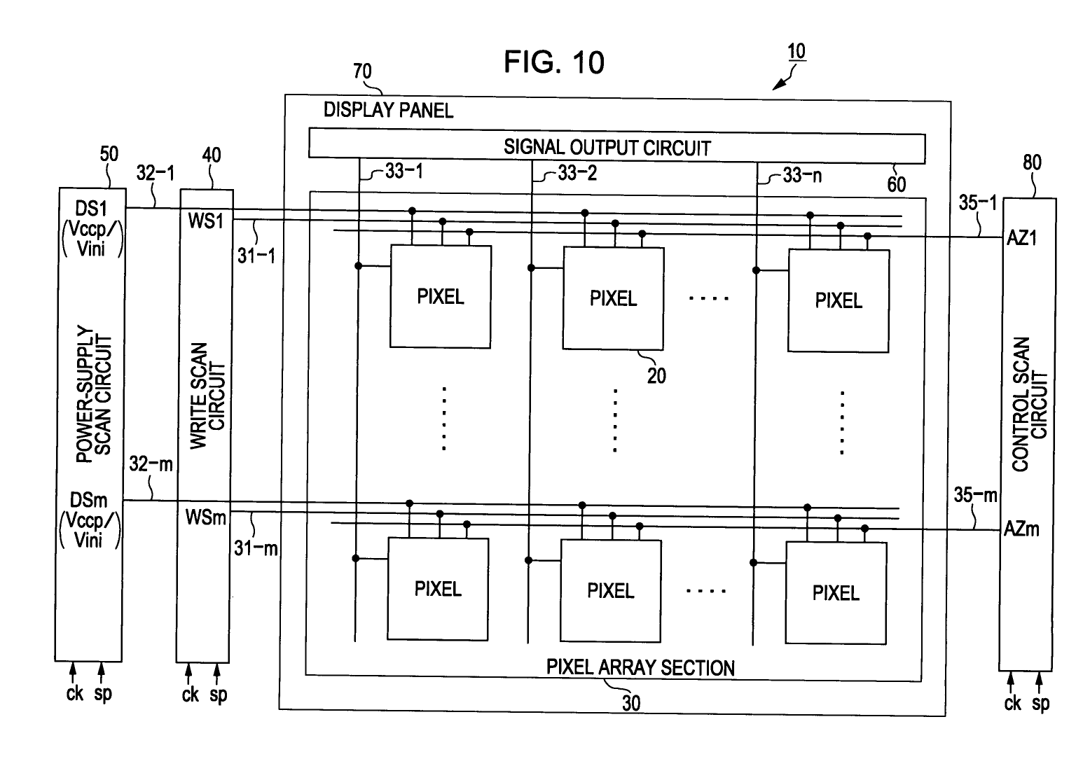

FIG. 10 is a system block diagram showing an overview of the configuration of an active matrix display device according to one embodiment of the present invention. In FIG. 10, the same sections as those shown in FIG. 1 are denoted by the same reference numerals. A description below is given of an example of an active matrix organic EL display device in which current-driven electro-optical elements (e.g., organic EL elements) having light-emission luminances that change in accordance with the values of currents flowing through the elements are used as light-emitting elements in pixels (pixel circuits).

As shown in FIG. 10, an organic EL display device 10 according to the present embodiment includes pixels 20 including light-emitting elements, a pixel array section 30 in which the pixels 20 are two-dimensionally arranged in a matrix, and a drive section disposed in the vicinity of the pixel array section 30.

In the present embodiment, the drive section has, as a scan drive section, a control scan circuit 80 in addition to a write scan circuit 40 and a power-supply scan circuit 50. The control scan circuit 80 is also disposed outside the display panel 70, similarly to the write scan circuit 40 and the power-supply scan circuit 50. The configurations of the write scan circuit 40, the power-supply scan circuit 50, and the signal output circuit 60 are the same as those in the reference example, and redundant descriptions thereof are not given below.

As in the case of the reference example, in the pixel 20 according to the present embodiment, a power-supply potential (Vccp/Vini) DS of a power-supply line 32 is switched to control light emission/non-emission of an organic EL element 21. A signal line 33 takes at least two values of a signal potential Vsig reflecting a gradation and a reference potential Vofs for initializing a gate potential Vg of the drive transistor 22. The number of values taken by the signal line 33, however, is not limited to two.

The control scan circuit 80 includes shift registers or the like that sequentially shift a start pulse sp in synchronization with a clock pulse ck. The control scan circuit 80 sequentially outputs control scan signals AZ (AZ1 to AZm) in synchronization with line-sequential scanning performed by the write scan circuit 40. The control scan signal AZ is supplied to the pixels 20 in corresponding rows through control scan lines 35-1 to 35-m provided in respective pixel rows in the pixel array section 30 along the row direction.

### (Pixel Circuit)

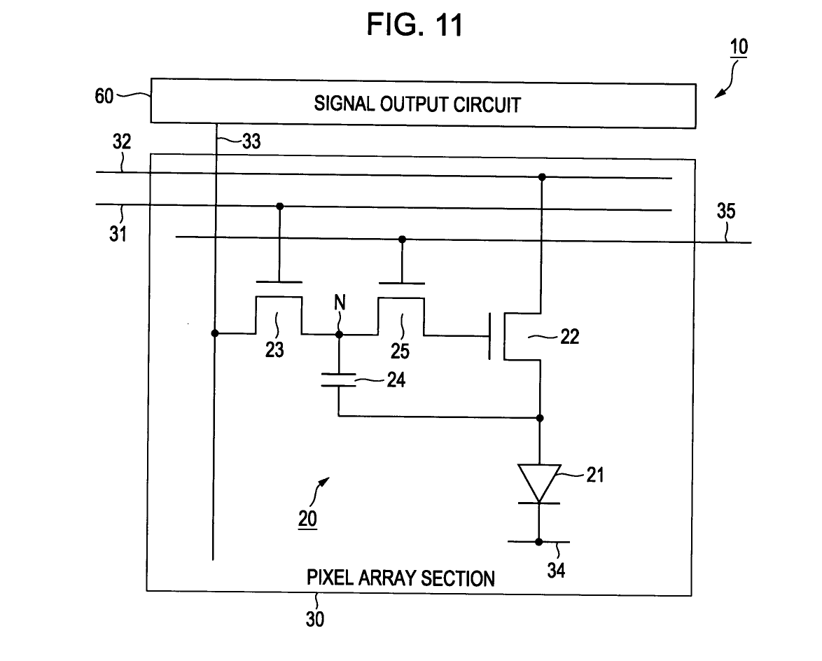

FIG. 11 is a circuit diagram showing an example of the configuration of a pixel (pixel circuit) 20 for use in the organic EL display device 10 according to the present embodiment. In FIG. 11, the same sections as those shown in FIG. 2 are denoted by the same reference numerals.

As shown in FIG. 11, the pixel 20 in the present embodiment includes, as a drive circuit for the organic EL element 21, a switching transistor 25 in addition to a drive transistor 22, the write transistor 23, and the storage capacitor 24.

That is, the pixel 20 has the same configuration as that of the pixel 20A shown in FIG. 2, except that the switching transistor 25 is added. Thus, the connection relationships and the functions of the drive transistor 22, the write transistor 23, and the storage capacitor 24 are not described hereinafter.

The switching transistor 25 is implemented by an re-channel TFT, which has the same conductivity type of the drive transistor 22 and the write transistor 23. However, this combination of the conductivity types of the drive transistor 22, the write transistor 23, and the switching transistor 25 is merely one example, and thus the combination thereof is not thereto.

The switching transistor 25 is connected between a gate electrode of the drive transistor 22 and a node N at which an electrode of the write transistor 23 and an electrode of the storage capacitor 24 are interconnected. The electrical connection (ON)/disconnection (OFF) of the switching transistor 25 are controlled by the control scan signal AZ supplied from the control scan circuit 80. The control scan signal AZ enters an inactive state (a low level in this example) at least in a period in which the write transistor 23 writes the signal voltage Vsig and enters an active state (a high level in this example) in other periods.

Through the control based on the control scan signal AZ, the switching transistor 25 breaks an electrical connection between the node N and the gate electrode of the drive transistor 22 during writing of the signal voltage Vsig of the video signal, to thereby prevent current from flowing to the drive transistor 22. That is, during writing of the signal voltage Vsig of the video signal, the switching transistor 25 functions as a control element for performing control so as to prevent current from flowing to the drive transistor 22.

The control element is not limited to a transistor, and may be implemented by any element that can selectively break an electrical connection between the node N and the gate electrode of the drive transistor 22. The structure of the pixel 20 is basically the same as that of the pixel 20A according to the reference example shown in FIG. 3 and is different therefrom in that the pixel 20 further has the switching transistor 25.

### Circuit Operation of Organic EL Display Device According to Embodiment

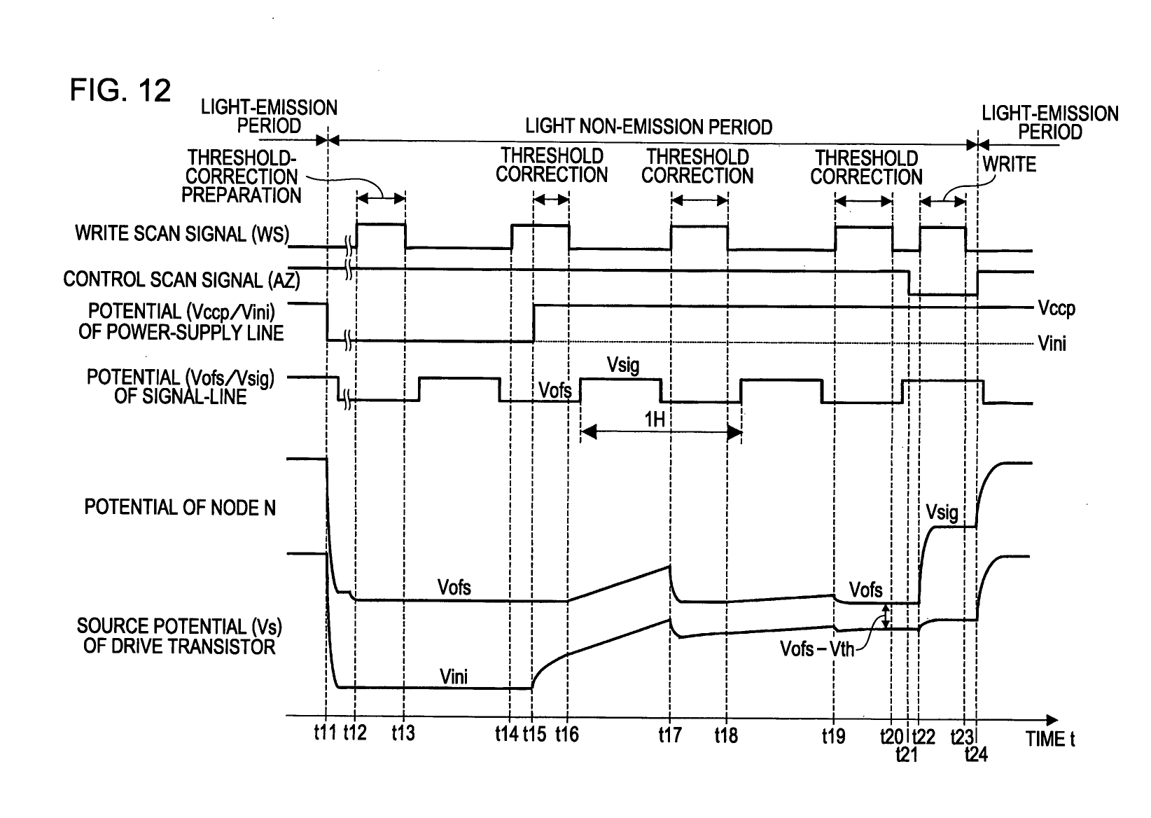

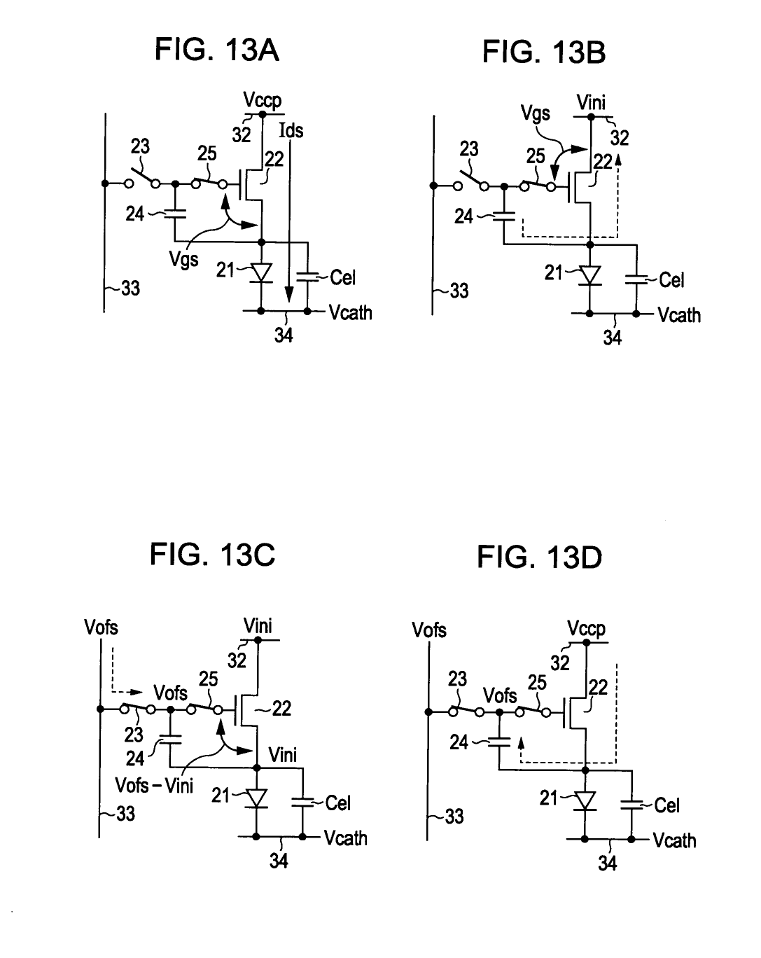

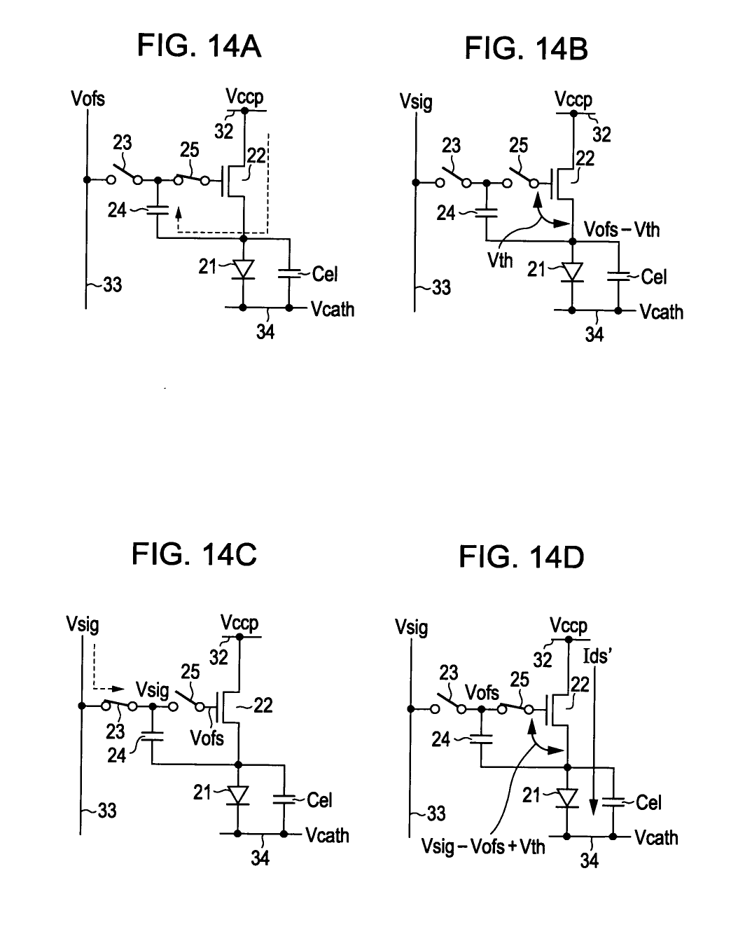

Next, the circuit operation of an organic EL display device 10 according to the present embodiment in which the pixels 20 having the above-described configuration are two-dimensionally arranged will be described with reference to operation diagrams shown in FIGS. 13A to 14D on the basis of the timing waveform diagram shown in FIG. 12.

In the operation diagrams shown in FIGS. 13A to 14D, the write transistor 23 and the switching transistor 25 are illustrated as symbols representing switches, for simplification of illustration. An equivalent capacitor Cel of the organic EL element 21 is also illustrated.

The timing waveform diagram in FIG. 12 shows a change in a potential (write scan signal) WS of the scan line 31, a change in the potential (control scan signal) AZ of the control scan line 35, a change in the potential DS of the power-supply line 32, a change in the potential of the node N, and a change in a source voltage Vs of the drive transistor 22.

The circuit operation according to the reference example has been described above in conjunction with an example using a drive method in which the threshold correction processing is performed only once. In contrast, the circuit operation according to the present embodiment involves a drive method for performing division threshold correction. In the division threshold correction, in addition to one horizontal scan period in which threshold correction processing is performed in conjunction with signal write processing, threshold correction processing is performed in multiple times, i.e., in multiple divided horizontal scan periods prior to the threshold correction processing. Needless to say, the circuit operation may employ a drive method in which the threshold correction processing is executed only once.

With the drive method for the division threshold correction, even when a time allocated to one horizontal scan period is reduced as a result of an increased number of pixels for higher definition, a sufficient amount of time can be ensured in multiple scan periods for the threshold correction periods. Thus, this drive method offers an advantage in that the threshold correction processing can be reliably performed.

### [Light Emission Period of Previous Frame]

In the timing waveform diagram of FIG. 12, a period before time t11 is a period in which the organic EL element 21 emits light for a previous frame (field). In the period of the light emission for the previous frame, the potential DS of the power-supply line 32 is a high potential Vccp. The write transistor 23 is in a non-conductive state and the switching transistor 25 is in a conductive state.

The drive transistor 22 is designed so that, at this point, it operates in its saturation region. Thus, as shown in FIG. 13A, a drive current (a drain-source current) Ids corresponding to a gate-source current Vgs of the drive transistor 22 is supplied from the power-supply line 32 to the organic EL element 21 through the drive transistor 22. Consequently, the organic EL element 21 emits light with a luminance corresponding to the current value of the drive current Ids.

### [Threshold Correction Preparation Period]

At time t11, the operation enters a new frame (present frame) for line-sequence scanning. As shown in FIG. 13B, the potential DS of the power-supply line 32 is switched from the high potential Vccp to the low potential Vini. At this point, when the low-potential Vini is smaller than the sum of a threshold voltage Vthel and a cathode potential Vcath of the organic EL element 21, that is, Vini<Vthel+Vcath is satisfied, the organic EL element 21 is put into a reverse biased state. Thus, the light emission of the organic EL element 21 is turned off. At this point, the anode potential of the organic EL element 21 becomes the low potential Vini.

Next, at time t12 at which the signal line 33 has the reference potential Vofs, the potential WS of the scan line 31 shifts from a low-potential side toward a high-potential side. Consequently, as shown in FIG. 13C, the write transistor 23 is put into a conductive state. At this point, since the gate voltage Vg of the drive transistor 22 reaches the reference potential Vofs, the gate-source voltage Vgs of the drive transistor 22 becomes a voltage expressed by Vofs-Vini.

In this case, unless Vofs−Vini is sufficiently larger than a threshold voltage Vth of the drive transistor 22, it is difficult to perform threshold correction processing described below. Thus, setting is performed so as to satisfy a potential relationship expressed by Vofs−Vini>Vth.

Thus, in the initialization for setting the gate voltage Vg of the drive transistor 22 to the reference potential Vofs and setting the source voltage Vs to the low potential Vini, processing for threshold correction preparation is performed prior to threshold correction processing described below. This threshold correction preparation is performed in the period of time t12 to time t13 in which the potential WS of the scan line 31 is high (i.e., the write scan signal WS is in the active state).

### [Division Vth-Correction Period]

Next, at time t14, the potential WS of the scan line 31 shifts from the low-potential side toward the high-potential side, so that the write transistor 23 is put into a conductive state again. At this point, the switching 25 remains in the conductive state. When the potential DS of the power-supply line 32 switches from the low potential Vini to the high potential Vccp at time t15, current flows through a path formed by the power-supply line 32, the drive transistor 22, the anode of the organic EL element 21, and the storage capacitor 24, as shown in FIG. 13D.

Since the organic EL element 21 can be expressed by a diode and a capacitor (an equivalent capacitance), current flowing through the drive transistor 22 is used to charge the storage capacitor 24 and the equivalent capacitor Cel, as long as an anode voltage Vel of the organic EL element 21 satisfies Vel≦Vcath+Vthel. In this case, when Vel≦Vcath+Vthel is satisfied, this means that leak current of the organic EL element 21 is considerably smaller than the current flowing through the drive transistor 22.

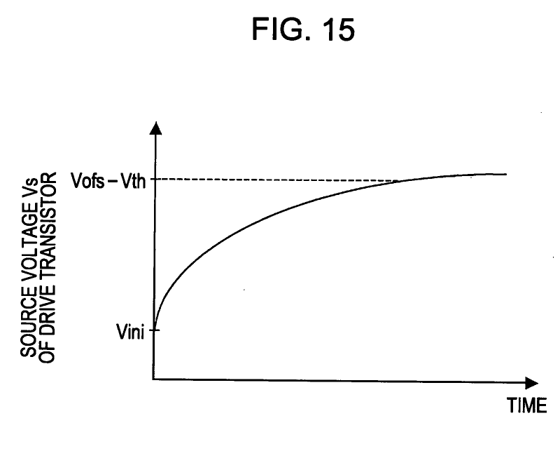

Through the charging operation, the anode voltage Vel of the organic EL element 21, i.e., the source voltage Vs of the drive transistor 22, increases with time, as shown in FIG. 15. That is, threshold correction processing is performed to change the source voltage Vs toward a potential, obtained by subtracting the threshold voltage Vth of the drive transistor 22 from the initialization potential Vofs, with reference to the initialization potential Vofs of the gate electrode of the drive transistor 22.

At time t16 after a predetermined time passes from time t15, the potential WS of the scan line 31 shifts from the high potential side toward the low potential side, so that the write transistor 23 is put into a non-conductive state. At this point, the switching transistor 25 remains in the conductive state. The period of time t15 to time t16 is a period in which a first round of the threshold correction is performed.

At this point, since the gate-source voltage Vgs of the drive transistor 22 is larger than the threshold Vth, current flows through a path formed by the power-supply line 32, the drive transistor 22, the anode of the organic EL element 21, and the storage capacitor 24, as shown in FIG. 14A. Consequently, the gate voltage Vg and the source voltage Vs of the drive transistor 22 increase. At this point, since the organic EL element 21 is reverse-biased, the organic EL element 21 does not emit light.

At time t17 at which the signal line 33 has the reference potential Vofs, the potential WS of the scan line 31 shifts again from the low-potential side toward the high-potential side, so that the write transistor 23 is put into a conductive state again. Consequently, the gate voltage Vg of the drive transistor 22 is initialized to the reference potential Vofs and a second round of the threshold correction processing is started. This second round of the threshold correction processing is performed until the potential WS of the scan line 31 shifts from the high potential side toward the low potential side at time t18 and the write transistor 23 is put into a non-conductive state.

Thereafter, in a period of time t19 to time t20, a third round of the threshold correction period is performed. In the example of this circuit operation, although the threshold correction processing is performed in three divided stages in three H periods, this is merely one example and the number of divided stages for the division Vth-correction is not limited to three.

As a result of repeating the processing operation of the division threshold correction, the gate-source voltage Vgs of the drive transistor 22 eventually settles to the threshold voltage Vth of the drive transistor 22. A voltage corresponding to the threshold voltage Vth is stored by the storage capacitor 24.

In the threshold correction processing, it is necessary to cause current to flow to the storage capacitor 24 and to prevent current from flowing to the organic EL element 21. Thus, the potential Vcath of the common power-supply line 34 is set so that the organic EL element 21 is in a cut-off state.

At time t20, the potential WS of the scan line 31 shifts from the high-potential side toward the low-potential side, so that the write transistor 23 is put into a non-conductive state. At this point, the gate electrode of the drive transistor 22 is electrically disconnected from the signal line 33, so that the gate electrode of the drive transistor 22 enters a floating state. However, since the gate-source voltage Vgs is equal to the threshold voltage Vth of the drive transistor 22, the drive transistor 22 is in a cut-off state. Thus, almost no drain-source current Ids flows to the drive transistor 22.

### [Signal Writing Period]

Next, at time t21, the potential (control scan signal) AZ of the control scan line 35 shifts from a high-potential side toward a low-potential side, so that the switching transistor 25 is put into a non-conductive state, as shown in FIG. 14B. At time t22 at which the potential of the signal line 33 is the signal voltage Vsig of the video signal, the potential WS of the scan line 31 shifts from the low-potential side toward the high-potential side. Consequently, as shown in FIG. 14C, the write transistor 23 is put into a conductive state again. Thus, the signal voltage Vsig of the video signal is written.

The signal voltage Vsig of the video signal is a voltage reflecting a gradation. Since the switching transistor 25 is in the non-conductive state during writing of the signal voltage Vsig of the video signal, the gate voltage Vg of the drive transistor 22 remains at the reference potential Vofs. The potential of the node N changes from the reference potential Vofs to the signal voltage Vsig. The change in the potential of the node N is then input to the anode electrode of the organic EL element 21 through the storage capacitor 24.

When the change in the voltage at the node N is represented by ΔVg, a change ΔVs in the source voltage Vs of the drive transistor 22 is given as:

ΔVs={Ccs/(Ccs+Cel)}·ΔVg (3).

In this case, when the capacitance value Ccs of the storage capacitor 24 is significantly small compared to the capacitance value Cel of the organic EL element 21, most of the change in the source voltage Vs of the drive transistor 22 can be ignored.

After the signal voltage Vsig of the video signal is written to the node N, at time t23, the potential WS of the scan line 31 shifts from the high potential side toward the low potential side, so that the write transistor 23 is put into a non-conductive state. Consequently, writing of the signal voltage Vsig is completed. At this point, since the gate electrode of the drive transistor 22 is electrically disconnected from the signal line 33, the gate electrode of the drive transistor 22 is put into a floating state.

### [Light Emission Period]

Next, at time t24, the potential of the control scan line 35 shifts from the low-potential side toward the high-potential side, so that the switching transistor 25 is put into a conductive state. Consequently, the gate-source voltage Vgs of the drive transistor 22 becomes substantially equal to a value expressed by Vsig−Vofs+Vth, as shown in FIG. 14D, and current Ids' according to equation (1) noted above starts to flow to the drive transistor 22. In response, the anode potential of the organic EL element 21 increases in accordance with the drain-source current Ids of the drive transistor 22.

When the anode potential of the organic EL element 21 exceeds Vthel+Vcath, the drive current (the drain-source current) Ids' starts to flow to the organic EL element 21 to thereby cause the organic EL element 21 to emit light with a luminance corresponding to the amount of drive current Ids'. An increase in the anode potential of the organic EL element 21 is equal to the increase in the source voltage Vs of the drive transistor 22.

When the source voltage Vs of the drive transistor 22 increases, the bootstrap operation of the storage capacitor 24 causes the gate voltage Vg of the drive transistor 22 to increase in conjunction with (so as to correspond to) the source voltage Vs. When the gain of the bootstrap is assumed to be 1 (an ideal value), the amount of increase in the gate voltage Vg is equal to the amount of increase in the source voltage Vs. Therefore, in the light-emission period, the gate-source voltage Vgs of the drive transistor 22 is maintained constant at Vsig−Vofs+Vth.

In the above-described series of circuit operations, the threshold correction processing is performed three times in a total of 3H periods, i.e., in the one horizontal scan period (1H) in which the writing processing of the video-signal signal voltage Vsig is executed and in 2H periods prior to the 1H period. In this example of the circuit operation, the threshold correction processing is ended by putting the write transistor 23 into a non-conductive state. The threshold correction processing can also be ended by causing the switching transistor 25, which serves as a control element, to prevent current from flowing to the drive transistor 22.

When the light emission period of the organic EL element 21 increases, the I-V characteristic thereof changes. Thus, the anode potential of the organic EL element 21 also changes. However, since the gate-source voltage Vgs of the drive transistor 22 is maintained constant, as described above, current flowing to the organic EL element 21 does not change even when the I-V characteristic changes. Thus, even when the I-V characteristic deteriorates, a constant amount of current flows continuously and thus the light-emission luminance of the organic EL element 21 does not change.

The organic EL display device 10 according to the present embodiment can compensate for variations in the I-V characteristic of the organic EL element 21 while correcting pixel-wise variations in the threshold voltage Vth of the drive transistor 22. Thus, it is possible to provide a uniform image quality without luminance irregularities. In addition, the use of n-channel transistors for all the transistors 22, 23, and 25 in the pixel 20 makes it possible to use an amorphous silicon process and thus makes it possible to reduce the cost of the organic EL display device 10.

Additionally, the organic EL display device 10 according to the present embodiment has a configuration that does not perform the mobility correction processing, which is executed in parallel with the signal write processing in the organic EL display device 10A according to the reference example. More specifically, during writing of the signal voltage Vsig of the video signal, the switching transistor 25 breaks an electrical connection between the node N and the gate electrode of the drive transistor 22 to thereby prevent current from flowing to the drive transistor 22.

When no current flows to the drive transistor 22 during writing of the signal voltage Vsig, applying negative feedback having the amount ΔV of feedback corresponding to the drain-source current Ids to the gate-source voltage Vgs can eliminate performing the mobility correction processing for correcting variations in the mobility μ. This is apparent from the description of the circuit operation of the organic EL display device 10A according to the above-described reference example.

The mobility correction processing is performed during flow of the drain-source current Ids to the drive transistor 22, while increasing the source voltage Vs of the drive transistor 22, as is clear from the timing waveform diagram shown in FIG. 4. Thus, when the configuration in which the mobility correction processing is performed is employed, the signal voltage Vsig of the video signal has to be set higher than that in a case in which the mobility correction processing is not performed.

Power P consumed by the driver that writes the video signal to the signal line 33 is given by:

P=C·V²·f (4),

where C indicates the parasitic capacitance of the signal line 33, V indicates the voltage of the video signal, and f indicates a drive frequency.

That is, the power P consumed by the driver is proportional to the square of the voltage V of the video signal. Thus, for a display device having small variations in the mobilities μ of the drive transistors 22, elimination of the mobility correction processing can set the signal voltage Vsig of the video signal to a low voltage and thus can reduce power consumed by the driver and also power consumed by the entire display device.

For a display device having large variations in the mobilities μ of the drive transistors 22, constantly putting the control scan signal AZ into an active state and leaving the switching transistor 25 into a conductive state allows the mobility correction processing to be executed in parallel with the signal writing processing. The circuit operation in this case is basically the same as the circuit operation of the organic EL display device 10A according to the reference example.

### 3. Modifications

In the above-described embodiment, during writing of the signal voltage Vsig of the video signal, the switching transistor 25 connected between the node N and the gate electrode of the drive transistor 22 is used as a control element for performing control for preventing current from flowing to the drive transistor 22. This arrangement, however, is merely one example, and the control element is not limited to the configuration for breaking an electrical connection between the node N and the gate electrode of the drive transistor 22. Modifications of such a configuration are described below.

### (First Modification of Pixel Configuration)

FIG. 16 is a circuit diagram showing an example of the configuration of a pixel according to a first modification. In FIG. 16, the same sections as those shown in FIG. 11 are denoted by the same reference numerals.

As shown in FIG. 16, a pixel (pixel circuit) 20-1 according to the first modification uses, as a control element, a switching transistor 26 connected between the power-supply line 32 and the drain electrode of the drive transistor 22. During writing of the signal voltage Vsig of the video signal, the switching transistor 26 breaks an electrical connection between the power supply line 32 and the drain electrode of the drive transistor 22 in response to the control scan signal AZ, to thereby prevent current from flowing to the drive transistor 22.

The switching transistor 26 may have any type of conductivity. However, the use of the same n-channel transistor for the switching transistor 26 as those of the drive transistor 22 and the write transistor 23 makes it possible to use an amorphous silicon process, thus offering an advantage of contributing to a reduction in the cost of the organic EL display device 10.

### (Second Modification of Pixel Configuration)

FIG. 17 is a circuit diagram showing an example of the configuration of a pixel according to a second modification. In FIG. 17, the same sections as those shown in FIG. 11 are denoted by the same reference numerals.

As shown in FIG. 17, a pixel 20-2 according to the second modification uses, as a control element, a switching transistor 27 connected between the source electrode of the drive transistor 22 and the anode electrode of the organic EL element 21. During writing of the signal voltage Vsig of the video signal, the switching transistor 27 breaks an electrical connection between the source electrode of the drive transistor 22 and the anode electrode of the organic EL element 21 in response to the control scan signal AZ, to thereby prevent current from flowing to the drive transistor 22.

The switching transistor 27 may have any type of conductivity. However, the use of the same n-channel transistor for the switching transistor 27 as those of the drive transistor 22 and the write transistor 23 makes it possible to use an amorphous silicon process, thus offering an advantage of contributing to a reduction in the cost of the organic EL display device 10.

Even with the pixels 20-1 and 20-2 according to the first and second modifications, when the signal voltage Vsig of the video signal is written, it is possible to prevent current from flowing to the drive transistor 22. Thus, as in the case of the above-described embodiment, it is possible to eliminate performing the mobility correction processing.

The configuration for breaking an electrical connection between the node N and the gate electrode of the drive transistor 22, as in the case of the above-described embodiment, is more preferable since the control element is not disposed on the current path between the power-supply line 32 and the organic EL element 21. When the control element is disposed on the current path between the power-supply line 32 and the organic EL element 21, a voltage drop occurs at the control element. Correspondingly, the power supply voltage has to be set high.

Although an example in which an organic EL display device that uses organic EL elements as electro-optical elements for the pixels has been described in the above embodiment, the present invention is not limited to the particular embodiment. More specifically, the present invention is also applicable to any display devices using current-driven electro-optical elements (light-emitting elements) having light-emission luminances that change in accordance with the values of currents flowing through the elements. Examples of such electro-optical elements include inorganic EL elements, LED (light emitting diode) elements, and semiconductor laser elements.

### 4. Application Examples

The above-described display device according to the present invention is applicable to display devices for electronic apparatuses in any field in which video signals input to the electronic apparatuses or video signals generated thereby are displayed in the form of an image or video.

The display device according to the embodiment of the present invention can reduce the video-signal signal voltage, thus making it possible to reduce the power consumed by the display device. Thus, the use of the display device according to the present invention as a display device for electronic apparatus in any field makes it possible to reduce the power consumed by the electronic apparatus.

The display device according to the embodiment of the present invention may also be implemented by a modular form having a sealed structure. The modular form corresponds to, for example, a display module formed by laminating opposing portions, made of transparent glass or the like, to a pixel array section. The transparent opposing portions may be provided with a color filter and a protection film as well as a light-shielding film. The display module may also be provided with, for example, an FPC (flexible printed circuit) or a circuit section for externally inputting/outputting a signal and so on to/from the pixel array section.

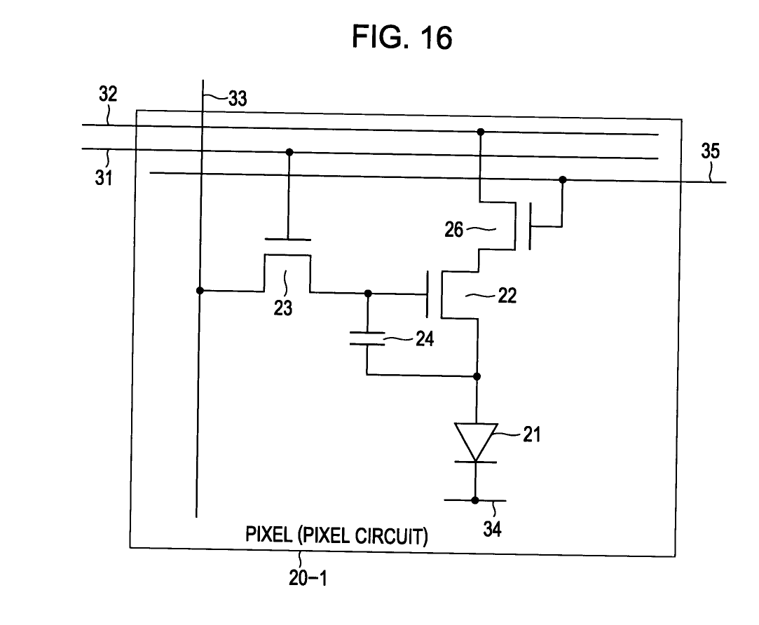

Specific examples of an electronic apparatus according to application examples of the present invention will be described below. For example, the present invention can be applied to display devices for various types of electronic apparatus, such as a television set, a digital camera, a notebook computer, a video camera, and a mobile terminal device such as a mobile phone, as shown in FIGS. 18 to 22G.

FIG. 18 is a perspective view showing the external appearance of a television set to which the present invention is applied. The television set according to the application example includes a video display screen section 101 having a front panel 102, a filter glass 103, and so on. The use of the display device according to the embodiment of the present invention as the video display screen section 101 provides a television set according to the application example.

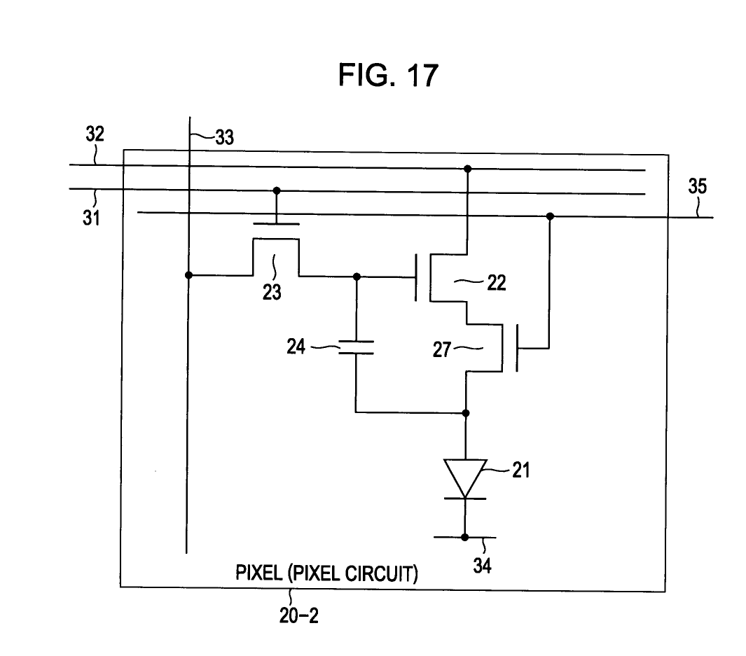

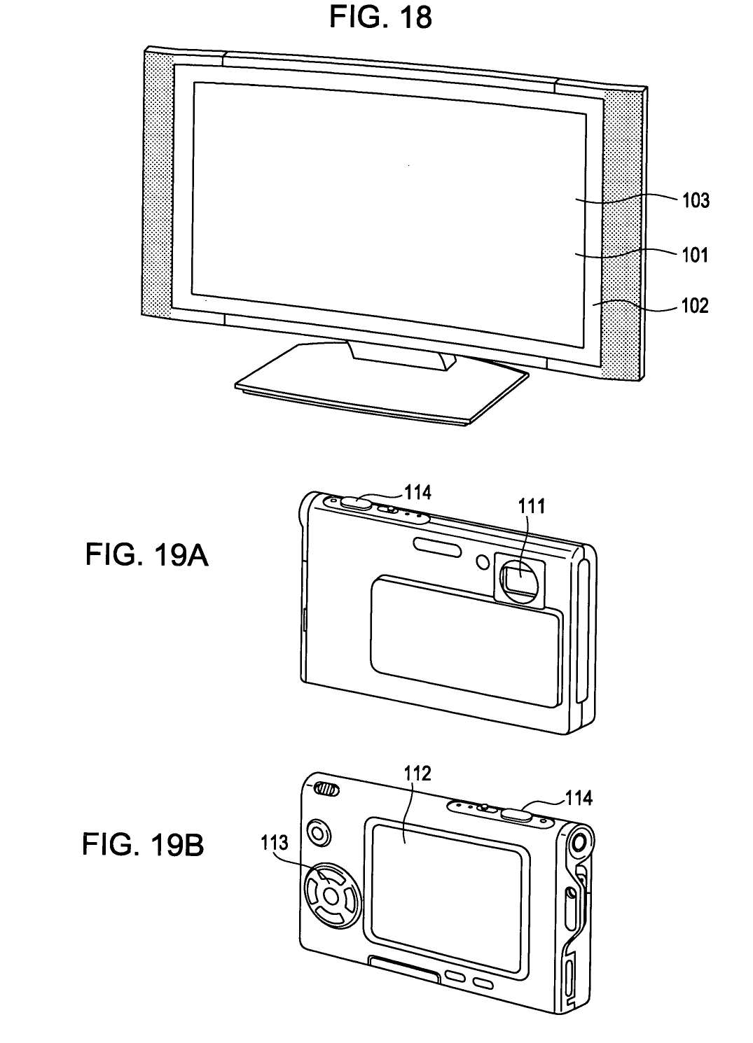

FIGS. 19A and 19B are a front perspective view and a rear perspective view, respectively, showing the external appearance of a digital camera to which the present invention is applied. The digital camera according to the application example includes a flashlight emitting section 111, a display section 112, a menu switch 113, a shutter button 114, and so on. The use of the display device according to the embodiment of present invention as the display section 112 provides a digital camera according to the application example.

FIG. 20 is a perspective view showing the external appearance of a notebook computer to which the present invention is applied. A notebook computer according to an application example has a configuration in which a main unit 121 includes a keyboard 122 for operation for inputting characters and so on, a display section 123 for displaying an image, and so on. The use of the display device according to the embodiment of the present invention as the display section 123 provides a notebook computer according to the application example.

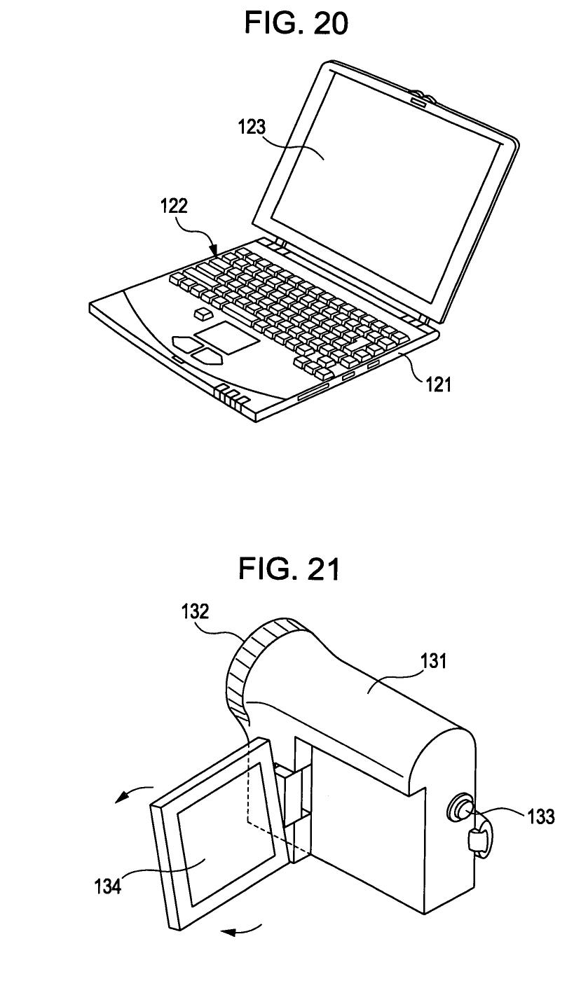

FIG. 21 is a perspective view showing the external appearance of a video camera to which the present invention is applied. A video camera according to an application example includes a main unit 131, a subject-shooting lens 132 provided at a front side surface thereof, a start/stop switch 133 for shooting, a display section 134, and so on. The use of the display device according to the embodiment of the present invention as the display section 134 provides a video camera according to the application example.

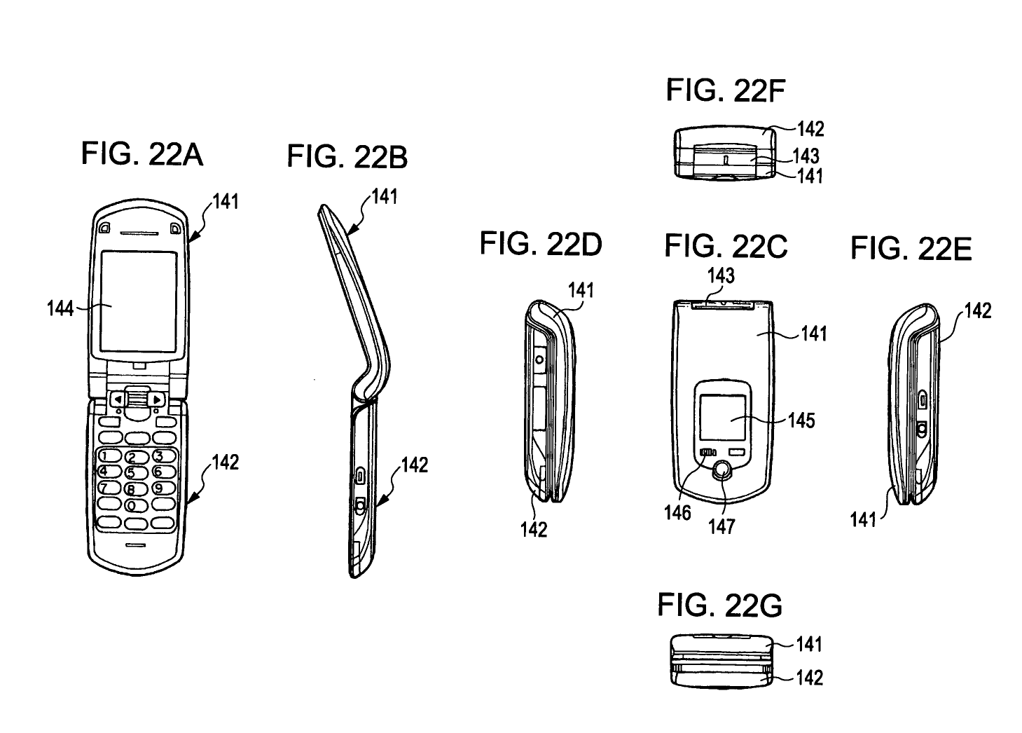

FIGS. 22A to 22G are external views of a mobile terminal device, for example, a mobile phone, to which the present embodiment is applied. Specifically, FIG. 22A is a front view of the mobile phone when it is opened, FIG. 22B is a side view thereof, FIG. 22C is a front view when the mobile phone is closed, FIG. 22D is a left side view, FIG. 22E is a right side view, FIG. 22F is a top view, and FIG. 22G is a bottom view.

The mobile phone according to the application example includes an upper casing 141, a lower casing 142, a coupling portion (a hinge portion, in this case) 143, a display 144, a sub display 145, a picture light 146, a camera 147, and so on. The use of the display device according to the embodiment of the present invention as the display 144 and/or the sub display 145 provides a mobile phone according to the application example.

The present application contains subject matter related to that disclosed in Japanese Priority Patent Application JP 2008-320597 filed in the Japan Patent Office on Dec. 17, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display device in which pixels are arranged in a matrix, each pixel comprising:
an electro-optical element;
a write transistor that writes a video signal;
a drive transistor that drives the electro-optical element in accordance with the video signal written by the write transistor;
a storage capacitor that is connected between a gate electrode and a source electrode of the drive transistor to store the video signal written by the write transistor; and
a control element that performs control so as to prevent current from flowing to the drive transistor when the write transistor writes the video signal.

2. The display device according to claim 1, wherein in the pixel, a power-supply potential of a power-supply that supplies drive current is supplied to the drive transistor is switched to control light emission and light non-emission of the electro-optical element.

3. The display device according to claim 2, wherein when the write transistor writes the video signal, the control element breaks an electrical connection between the gate electrode of the drive transistor and a node of the write transistor and the storage capacitor.

4. The display device according to claim 2, wherein when the write transistor writes the video signal, the control element breaks an electrical connection between the drive transistor and the power-supply line.

5. The display device according to claim 2, wherein when the write transistor writes the video signal, the control element breaks an electrical connection between the drive transistor and the electro-optical element.

6. The display device according to claim 1, wherein the signal line that supplies the video signal takes at least two values of a signal potential reflecting a gradation and a reference potential for initializing a gate voltage of the drive transistor.

7. The display device according to claim 6, wherein when the signal line has the reference potential, the control element causes current to flow to the drive transistor, the write transistor writes the reference potential to initialize the gate voltage of the drive transistor, and threshold correction processing for changing a source voltage of the drive transistor toward a potential obtained by subtracting a threshold voltage of the drive transistor from an initialization potential is performed.

8. The display device according to claim 7, wherein the threshold correction processing is ended by putting the write transistor into a non-conductive state or causing the control element to prevent current from flowing to the drive transistor.

9. A drive method for a display device in which pixels are arranged in a matrix, each pixel having an electro-optical element, a write transistor that writes a video signal, a drive transistor that drives the electro-optical element in accordance with the video signal written by the write transistor, a storage capacitor that is connected between a gate electrode and a source electrode of the drive transistor to store the video signal written by the write transistor, the drive method comprising the step of:
preventing current from flowing to the drive transistor when the write transistor writes the video signal.

10. An electronic apparatus having a display device in which pixels are arranged in a matrix, each pixel comprising:
an electro-optical element;
a write transistor that writes a video signal;
a drive transistor that drives the electro-optical element in accordance with the video signal written by the write transistor;
a storage capacitor that is connected between a gate electrode and a source electrode of the drive transistor to store the video signal written by the write transistor; and
a control element that performs control so as to prevent current from flowing to the drive transistor when the write transistor writes the video signal.
